(19) United States
(12) Patent Application Publication
(10) Pub. No.: US 2025/0220547 A1
(43) Pub. Date: Jul. 3, 2025

(54) CONFLICT RESOLUTION FOR CONDITIONAL MOBILITY IN WIRELESS COMMUNICATION SYSTEM

(71) Applicant: LG ELECTRONICS INC., Seoul (KR)

(72) Inventors: Hongsuk KIM, Seoul (KR); Sunghoon JUNG, Seoul (KR)

(73) Assignee: LG ELECTRONICS INC., Seoul (KR)

(21) Appl. No.: 18/878,827

(22) PCT Filed: Jun. 26, 2023
(86) PCT No.: PCT/KR2023/008857

§ 371 Date: Dec. 24, 2024

Related U.S. Application Data
(60) Provisional application No. 63/355,100, filed on Jun. 24, 2022.

(51) Int. Cl. H04W 36/36; H04W 36/00; H04W 60/04; H04W 76/10

(52) U.S. Cl. CPC H04W 36/362; H04W 36/0069; H04W 36/0072; H04W 60/04; H04W 76/10

(57) ABSTRACT

The present disclosure relates to conflict resolution for conditional mobility in wireless communications. According to an embodiment of the present disclosure, a method performed by a user equipment (UE) configured to operate in a wireless communication system comprises: establishing a connection with a first network; receiving, from the first network, a first conditional reconfiguration for a first candidate cell; establishing a connection with the second network; performing operations on a serving frequency of the second network based on the connection with the second network; and based on at least one frequency related to the first conditional reconfiguration conflicting the serving frequency of the second network, transmitting, to the first network, information for the at least one frequency, after the connection with the second network is established.

### CROSS-REFERENCE TO RELATED APPLICATION(S)

This application is the National Stage filing under 35 U.S.C. 371 of International Application No. PCT/KR2023/008857, filed on Jun. 26, 2023, which claims the benefit of U.S. Provisional Application No. 63/355,100, filed on Jun. 24, 2022, the contents of which are all incorporated by reference herein in their entirety.

### TECHNICAL FIELD

The present disclosure relates to conflict resolution for conditional mobility in wireless communications.

### BACKGROUND

3rd Generation Partnership Project (3GPP) Long-Term Evolution (LTE) is a technology for enabling high-speed packet communications. Many schemes have been proposed for the LTE objective including those that aim to reduce user and provider costs, improve service quality, and expand and improve coverage and system capacity. The 3GPP LTE requires reduced cost per bit, increased service availability, flexible use of a frequency band, a simple structure, an open interface, and adequate power consumption of a terminal as an upper-level requirement.

Work has started in International Telecommunication Union (ITU) and 3GPP to develop requirements and specifications for New Radio (NR) systems. 3GPP has to identify and develop the technology components needed for successfully standardizing the new RAT timely satisfying both the urgent market needs, and the more long-term requirements set forth by the ITU Radio communication sector (ITU-R) International Mobile Telecommunications (IMT)-2020 process. Further, the NR should be able to use any spectrum band ranging at least up to 100 GHz that may be made available for wireless communications even in a more distant future.

The NR targets a single technical framework addressing all usage scenarios, requirements and deployment scenarios including enhanced Mobile BroadBand (eMBB), massive Machine Type Communications (mMTC), Ultra-Reliable and Low Latency Communications (URLLC), etc. The NR shall be inherently forward compatible.

In wireless communications, a user equipment (UE) may receive a conditional reconfiguration, and perform a conditional mobility based on the conditional reconfiguration. However, there may be a case UE's capability does not support simultaneously performing operations on at least one frequency configured by the conditional reconfiguration and operations on other radio resources. This may be referred to as there is a capability conflict. Conflict may occur various situations, such as in multiple networks related to multiple universal subscriber identity module (MUSIM) operations.

### SUMMARY

An aspect of the present disclosure is to provide method and apparatus for conflict resolution for conditional mobility in a wireless communication system.

Another aspect of the present disclosure is to provide method and apparatus for conflict resolution for conditional mobility in MUSIM operations in a wireless communication system.

According to an embodiment of the present disclosure, a method performed by a user equipment (UE) configured to operate in a wireless communication system comprises: establishing a connection with a first network; receiving, from the first network, a first conditional reconfiguration for a first candidate cell; establishing a connection with the second network; performing operations on a serving frequency of the second network based on the connection with the second network; and based on at least one frequency related to the first conditional reconfiguration conflicting the serving frequency of the second network, transmitting, to the first network, information for the at least one frequency, after the connection with the second network is established.

According to an embodiment of the present disclosure, a user equipment (UE) configured to operate in a wireless communication system comprises: at least one transceiver; at least one processor; and at least one memory operatively coupled to the at least one processor and storing instructions that, based on being executed by the at least one processor, perform operations comprising: establishing a connection with a first network; receiving, from the first network, a first conditional reconfiguration for a first candidate cell; establishing a connection with the second network; performing operations on a serving frequency of the second network based on the connection with the second network; and based on at least one frequency related to the first conditional reconfiguration conflicting the serving frequency of the second network, transmitting, to the first network, information for the at least one frequency, after the connection with the second network is established.

According to an embodiment of the present disclosure, a network node in a first network configured to operate in a wireless communication system comprises: at least one transceiver; at least one processor; and at least one memory operatively coupled to the at least one processor and storing instructions that, based on being executed by the at least one processor, perform operations comprising: establishing a connection with a user equipment (UE); transmitting, to the UE, a first conditional reconfiguration for a first candidate cell; and after the UE has established a connection with a second network, based on at least one frequency related to the first conditional reconfiguration conflicting a serving frequency of the second network, receiving information for the at least one frequency from the UE.

According to an embodiment of the present disclosure, a method performed by a network node in a first network configured to operate in a wireless communication system comprises: establishing a connection with a user equipment (UE); transmitting, to the UE, a first conditional reconfiguration for a first candidate cell; and after the UE has established a connection with a second network, based on at least one frequency related to the first conditional reconfiguration conflicting a serving frequency of the second network, receiving information for the at least one frequency from the UE.

According to an embodiment of the present disclosure, an apparatus adapted to operate in a wireless communication system comprises: at least processor; and at least one memory operatively coupled to the at least one processor and storing instructions that, based on being executed by the at least one processor, perform operations comprising: establishing a connection with a first network; receiving, from the first network, a first conditional reconfiguration for a first candidate cell; establishing a connection with the second network; performing operations on a serving frequency of the second network based on the connection with the second network; and based on at least one frequency related to the first conditional reconfiguration conflicting the serving frequency of the second network, transmitting, to the first network, information for the at least one frequency, after the connection with the second network is established.

According to an embodiment of the present disclosure, a non-transitory computer readable medium (CRM) has stored thereon a program code implementing instructions that, based on being executed by at least one processor, perform operations comprising: establishing a connection with a first network; receiving, from the first network, a first conditional reconfiguration for a first candidate cell; establishing a connection with the second network; performing operations on a serving frequency of the second network based on the connection with the second network; and based on at least one frequency related to the first conditional reconfiguration conflicting the serving frequency of the second network, transmitting, to the first network, information for the at least one frequency, after the connection with the second network is established.

The present disclosure may have various advantageous effects.

For example, since the UE can request updated configuration (temporarily restricted configuration for the conditional reconfiguration) to the network before applying the conditional reconfiguration, the UE can prevent unnecessary data transmission delay caused by the conflict due to MUSIM operation after applying the conditional reconfiguration.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

### BRIEF DESCRIPTION OF THE DRAWINGS

FIG. 1 shows an example of a communication system to which implementations of the present disclosure is applied.

FIG. 2 shows an example of wireless devices to which implementations of the present disclosure is applied.

FIG. 3 shows an example of UE to which implementations of the present disclosure is applied.

FIGS. 4 and 5 show an example of protocol stacks in a 3GPP based wireless communication system to which implementations of the present disclosure is applied.

FIG. 6 shows a frame structure in a 3GPP based wireless communication system to which implementations of the present disclosure is applied.

FIG. 7 shows a data flow example in the 3GPP NR system to which implementations of the present disclosure is applied.

FIG. 8 shows an example of a wireless environment in which a MUSIM device operates according to an embodiment of the present disclosure.

FIG. 9 shows an example of a conditional mobility procedure to which technical features of the present disclosure can be applied.

FIG. 10 shows an example of a method performed by a UE according to an embodiment of the present disclosure.

FIG. 11 shows an example of a method performed by a network node in a first network according to an embodiment of the present disclosure.

FIG. 12 shows an example of a signal flow for MUSIM operation according to an embodiment of the present disclosure.

### DETAILED DESCRIPTION

The following techniques, apparatuses, and systems may be applied to a variety of wireless multiple access systems. Examples of the multiple access systems include a Code Division Multiple Access (CDMA) system, a Frequency Division Multiple Access (FDMA) system, a Time Division Multiple Access (TDMA) system, an Orthogonal Frequency Division Multiple Access (OFDMA) system, a Single Carrier Frequency Division Multiple Access (SC-FDMA) system, and a Multi Carrier Frequency Division Multiple Access (MC-FDMA) system.

CDMA may be embodied through radio technology such as Universal Terrestrial Radio Access (UTRA) or CDMA2000. TDMA may be embodied through radio technology such as Global System for Mobile communications (GSM), General Packet Radio Service (GPRS), or Enhanced Data rates for GSM Evolution (EDGE). OFDMA may be embodied through radio technology such as Institute of Electrical and Electronics Engineers (IEEE) 802.11 (Wi-Fi), IEEE 802.16 (WiMAX), IEEE 802.20, or Evolved UTRA (E-UTRA). UTRA is a part of a Universal Mobile Telecommunications System (UMTS). 3rd Generation Partnership Project (3GPP) Long-Term Evolution (LTE) is a part of Evolved UMTS (E-UMTS) using E-UTRA. 3GPP LTE employs OFDMA in downlink (DL) and SC-FDMA in uplink (UL). Evolution of 3GPP LTE includes LTE-Advanced (LTE-A), LTE-A Pro, and/or 5G New Radio (NR).

For convenience of description, implementations of the present disclosure are mainly described in regards to a 3GPP based wireless communication system. However, the technical features of the present disclosure are not limited thereto. For example, although the following detailed description is given based on a mobile communication system corresponding to a 3GPP based wireless communication system, aspects of the present disclosure that are not limited to 3GPP based wireless communication system are applicable to other mobile communication systems.

For terms and technologies which are not specifically described among the terms of and technologies employed in the present disclosure, the wireless communication standard documents published before the present disclosure may be referenced.

In the present disclosure, “A or B” may mean “only A”, “only B”, or “both A and B”.

In other words, “A or B” in the present disclosure may be interpreted as “A and/or B”. For example, “A, B or C” in the present disclosure may mean “only A”, “only B”, “only C”, or “any combination of A, B and C”.

In the present disclosure, slash (/) or comma (,) may mean “and/or”. For example, “A/B” may mean “A and/or B”. Accordingly, “A/B” may mean “only A”, “only B”, or “both A and B”. For example, “A, B, C” may mean “A, B or C”.

In the present disclosure, “at least one of A and B” may mean “only A”, “only B” or “both A and B”. In addition, the expression “at least one of A or B” or “at least one of A and/or B” in the present disclosure may be interpreted as same as “at least one of A and B”.

In addition, in the present disclosure, “at least one of A, B and C” may mean “only A”, “only B”, “only C”, or “any combination of A, B and C”. In addition, “at least one of A, B or C” or “at least one of A, B and/or C” may mean “at least one of A, B and C”.

Also, parentheses used in the present disclosure may mean “for example”. In detail, when it is shown as “control information (PDCCH)”, “PDCCH” may be proposed as an example of “control information”. In other words, “control information” in the present disclosure is not limited to “PDCCH”, and “PDCCH” may be proposed as an example of “control information”. In addition, even when shown as “control information (i.e., PDCCH)”, “PDCCH” may be proposed as an example of “control information”.

Technical features that are separately described in one drawing in the present disclosure may be implemented separately or simultaneously.

Although not limited thereto, various descriptions, functions, procedures, suggestions, methods and/or operational flowcharts of the present disclosure disclosed herein can be applied to various fields requiring wireless communication and/or connection (e.g., 5G) between devices.

Hereinafter, the present disclosure will be described in more detail with reference to drawings. The same reference numerals in the following drawings and/or descriptions may refer to the same and/or corresponding hardware blocks, software blocks, and/or functional blocks unless otherwise indicated.

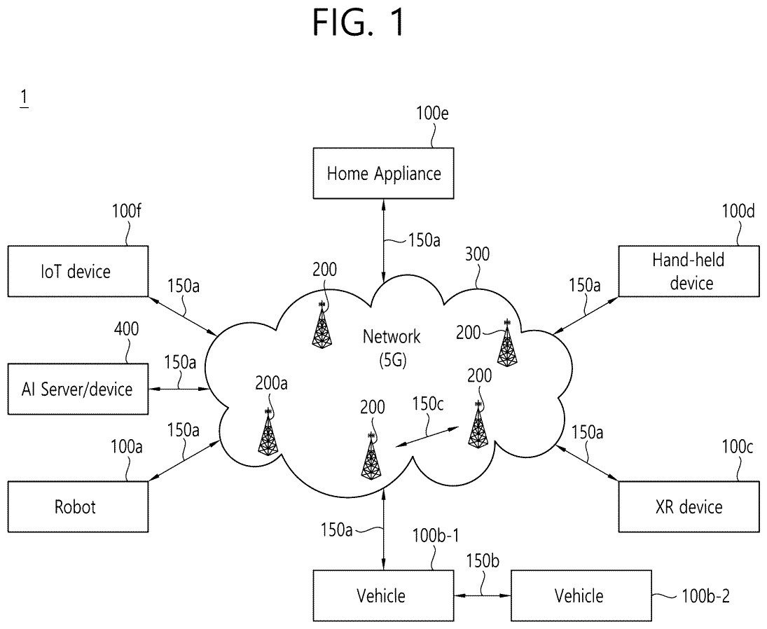

FIG. 1 shows an example of a communication system to which implementations of the present disclosure is applied.

The 5G usage scenarios shown in FIG. 1 are only exemplary, and the technical features of the present disclosure can be applied to other 5G usage scenarios which are not shown in FIG. 1.

Three main requirement categories for 5G include (1) a category of enhanced Mobile BroadBand (eMBB), (2) a category of massive Machine Type Communication (mMTC), and (3) a category of Ultra-Reliable and Low Latency Communications (URLLC).

Referring to FIG. 1, the communication system 1 includes wireless devices 100a to 100f, Base Stations (BSs) 200, and a network 300. Although FIG. 1 illustrates a 5G network as an example of the network of the communication system 1, the implementations of the present disclosure are not limited to the 5G system, and can be applied to the future communication system beyond the 5G system.

The BSs 200 and the network 300 may be implemented as wireless devices and a specific wireless device may operate as a BS/network node with respect to other wireless devices.

The wireless devices 100a to 100f represent devices performing communication using Radio Access Technology (RAT) (e.g., 5G NR or LTE) and may be referred to as communication/radio/5G devices. The wireless devices 100a to 100f may include, without being limited to, a robot 100a, vehicles 100b-1 and 100b-2, an eXtended Reality (XR) device 100c, a hand-held device 100d, a home appliance 100e, an Internet-of-Things (IoT) device 100f, and an Artificial Intelligence (AI) device/server 400. For example, the vehicles may include a vehicle having a wireless communication function, an autonomous driving vehicle, and a vehicle capable of performing communication between vehicles. The vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter.

In the present disclosure, the wireless devices 100a to 100f may be called User Equipments (UEs). A UE may include, for example, a cellular phone, a smartphone, a laptop computer, a digital broadcast terminal, a Personal Digital Assistant (PDA), a Portable Multimedia Player (PMP), a navigation system, a slate Personal Computer (PC), a tablet PC, an ultrabook, a vehicle, a vehicle having an autonomous traveling function, a connected car, an UAV, an AI module, a robot, an AR device, a VR device, an MR device, a hologram device, a public safety device, an MTC device, an IoT device, a medical device, a FinTech device (or a financial device), a security device, a weather/environment device, a device related to a 5G service, or a device related to a fourth industrial revolution field.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, a 5G (e.g., NR) network, and a beyond-5G network. Although the wireless devices 100a to 100f may communicate with each other through the BSs 200/network 300, the wireless devices 100a to 100f may perform direct communication (e.g., sidelink communication) with each other without passing through the BSs 200/network 300. For example, the vehicles 100b-1 and 100b-2 may perform direct communication (e.g., Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b and 150c may be established between the wireless devices 100a to 100f and/or between wireless device 100a to 100f and BS 200 and/or between BSs 200. Herein, the wireless communication/connections may be established through various RATs (e.g., 5G NR) such as uplink/downlink communication 150a, sidelink communication (or Device-to-Device (D2D) communication) 150b, inter-base station communication 150c (e.g., relay, Integrated Access and Backhaul (IAB)), etc. The wireless devices 100a to 100f and the BSs 200/the wireless devices 100a to 100f may transmit/receive radio signals to/from each other through the wireless communication/connections 150a, 150b and 150c. For example, the wireless communication/connections 150a, 150b and 150c may transmit/receive signals through various physical channels. To this end, at least a part of various configuration information configuring processes, various signal processing processes (e.g., channel encoding/decoding, modulation/demodulation, and resource mapping/de-mapping), and resource allocating processes, for transmitting/receiving radio signals, may be performed based on the various proposals of the present disclosure.

NR supports multiples numerologies (and/or multiple Sub-Carrier Spacings (SCS)) to support various 5G services. For example, if SCS is 15 kHz, wide area can be supported in traditional cellular bands, and if SCS is 30 kHz/60 kHz, dense-urban, lower latency, and wider carrier bandwidth can be supported. If SCS is 60 kHz or higher, bandwidths greater than 24.25 GHz can be supported to overcome phase noise.

The NR frequency band may be defined as two types of frequency range, i.e., Frequency Range 1 (FR1) and Frequency Range 2 (FR2). The numerical value of the frequency range may be changed. For example, the frequency ranges of the two types (FR1 and FR2) may be as shown in Table 1 below. For ease of explanation, in the frequency ranges used in the NR system, FR1 may mean “sub 6 GHz range”, FR2 may mean “above 6 GHz range,” and may be referred to as millimeter Wave (mmW).

TABLE 1

| Frequency Range | Corresponding | |
|---|---|---|
| designation | frequency range | Subcarrier Spacing |
| FR1 | 450 MHz-6000 MHz | 15, 30, 60 kHz |
| FR2 | 24250 MHz-52600 MHz | 60, 120, 240 kHz |

As mentioned above, the numerical value of the frequency range of the NR system may be changed. For example, FR1 may include a frequency band of 410 MHz to 7125 MHz as shown in Table 2 below. That is, FR1 may include a frequency band of 6 GHz (or 5850, 5900, 5925 MHz, etc.) or more. For example, a frequency band of 6 GHz (or 5850, 5900, 5925 MHz, etc.) or more included in FR1 may include an unlicensed band. Unlicensed bands may be used for a variety of purposes, for example for communication for vehicles (e.g., autonomous driving).

TABLE 2

| Frequency Range | Corresponding | |
|---|---|---|
| designation | frequency range | Subcarrier Spacing |
| FR1 | 410 MHz-7125 MHz | 15, 30, 60 kHz |
| FR2 | 24250 MHz-52600 MHz | 60, 120, 240 kHz |

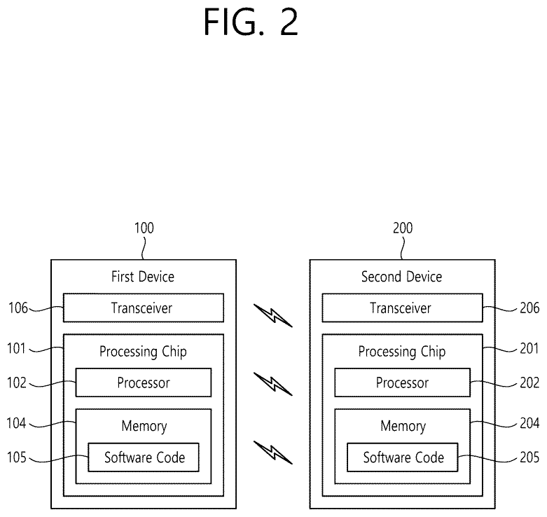

Here, the radio communication technologies implemented in the wireless devices in the present disclosure may include NarrowBand IoT (NB-IoT) technology for low-power communication as well as LTE, NR and 6G. For example, NB-IoT technology may be an example of Low Power Wide Area Network (LPWAN) technology, may be implemented in specifications such as LTE Cat NB1 and/or LTE Cat NB2, and may not be limited to the above-mentioned names. Additionally and/or alternatively, the radio communication technologies implemented in the wireless devices in the present disclosure may communicate based on LTE-M technology. For example, LTE-M technology may be an example of LPWAN technology and be called by various names such as enhanced MTC (eMTC). For example, LTE-M technology may be implemented in at least one of the various specifications, such as 1) LTE Cat 0, 2) LTE Cat M1, 3) LTE Cat M2, 4) LTE non-bandwidth limited (non-BL), 5) LTE-MTC, 6) LTE Machine Type Communication, and/or 7) LTE M, and may not be limited to the above-mentioned names. Additionally and/or alternatively, the radio communication technologies implemented in the wireless devices in the present disclosure may include at least one of ZigBee, Bluetooth, and/or LPWAN which take into account low-power communication, and may not be limited to the above-mentioned names. For example, ZigBee technology may generate Personal Area Networks (PANs) associated with small/low-power digital communication based on various specifications such as IEEE 802.15.4 and may be called various names. FIG. 2 shows an example of wireless devices to which implementations of the present disclosure is applied.

In FIG. 2, The first wireless device 100 and/or the second wireless device 200 may be implemented in various forms according to use cases/services. For example, {the first wireless device 100 and the second wireless device 200} may correspond to at least one of {the wireless device 100a to 100f and the BS 200}, {the wireless device 100a to 100f and the wireless device 100a to 100f} and/or {the BS 200 and the BS 200} of FIG. 1. The first wireless device 100 and/or the second wireless device 200 may be configured by various elements, devices/parts, and/or modules.

The first wireless device 100 may include at least one transceiver, such as a transceiver 106, at least one processing chip, such as a processing chip 101, and/or one or more antennas 108.

The processing chip 101 may include at least one processor, such a processor 102, and at least one memory, such as a memory 104. Additional and/or alternatively, the memory 104 may be placed outside of the processing chip 101.

The processor 102 may control the memory 104 and/or the transceiver 106 and may be adapted to implement the descriptions, functions, procedures, suggestions, methods and/or operational flowcharts described in the present disclosure. For example, the processor 102 may process information within the memory 104 to generate first information/signals and then transmit radio signals including the first information/signals through the transceiver 106. The processor 102 may receive radio signals including second information/signals through the transceiver 106 and then store information obtained by processing the second information/signals in the memory 104.

The memory 104 may be operably connectable to the processor 102. The memory 104 may store various types of information and/or instructions. The memory 104 may store a firmware and/or a software code 105 which implements codes, commands, and/or a set of commands that, when executed by the processor 102, perform the descriptions, functions, procedures, suggestions, methods and/or operational flowcharts disclosed in the present disclosure. For example, the firmware and/or the software code 105 may implement instructions that, when executed by the processor 102, perform the descriptions, functions, procedures, suggestions, methods and/or operational flowcharts disclosed in the present disclosure. For example, the firmware and/or the software code 105 may control the processor 102 to perform one or more protocols. For example, the firmware and/or the software code 105 may control the processor 102 to perform one or more layers of the radio interface protocol.

Herein, the processor 102 and the memory 104 may be a part of a communication modem/circuit/chip designed to implement RAT (e.g., LTE or NR). The transceiver 106 may be connected to the processor 102 and transmit and/or receive radio signals through one or more antennas 108. Each of the transceiver 106 may include a transmitter and/or a receiver. The transceiver 106 may be interchangeably used with Radio Frequency (RF) unit(s). In the present disclosure, the first wireless device 100 may represent a communication modem/circuit/chip.

The second wireless device 200 may include at least one transceiver, such as a transceiver 206, at least one processing chip, such as a processing chip 201, and/or one or more antennas 208.

The processing chip 201 may include at least one processor, such a processor 202, and at least one memory, such as a memory 204. Additional and/or alternatively, the memory 204 may be placed outside of the processing chip 201.

The processor 202 may control the memory 204 and/or the transceiver 206 and may be adapted to implement the descriptions, functions, procedures, suggestions, methods and/or operational flowcharts described in the present disclosure. For example, the processor 202 may process information within the memory 204 to generate third information/signals and then transmit radio signals including the third information/signals through the transceiver 206. The processor 202 may receive radio signals including fourth information/signals through the transceiver 106 and then store information obtained by processing the fourth information/signals in the memory 204.

The memory 204 may be operably connectable to the processor 202. The memory 204 may store various types of information and/or instructions. The memory 204 may store a firmware and/or a software code 205 which implements codes, commands, and/or a set of commands that, when executed by the processor 202, perform the descriptions, functions, procedures, suggestions, methods and/or operational flowcharts disclosed in the present disclosure. For example, the firmware and/or the software code 205 may implement instructions that, when executed by the processor 202, perform the descriptions, functions, procedures, suggestions, methods and/or operational flowcharts disclosed in the present disclosure. For example, the firmware and/or the software code 205 may control the processor 202 to perform one or more protocols. For example, the firmware and/or the software code 205 may control the processor 202 to perform one or more layers of the radio interface protocol.

Herein, the processor 202 and the memory 204 may be a part of a communication modem/circuit/chip designed to implement RAT (e.g., LTE or NR). The transceiver 206 may be connected to the processor 202 and transmit and/or receive radio signals through one or more antennas 208. Each of the transceiver 206 may include a transmitter and/or a receiver. The transceiver 206 may be interchangeably used with RF unit. In the present disclosure, the second wireless device 200 may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as Physical (PHY) layer, Media Access Control (MAC) layer, Radio Link Control (RLC) layer, Packet Data Convergence Protocol (PDCP) layer, Radio Resource Control (RRC) layer, and Service Data Adaptation Protocol (SDAP) layer). The one or more processors 102 and 202 may generate one or more Protocol Data Units (PDUs), one or more Service Data Unit (SDUs), messages, control information, data, or information according to the descriptions, functions, procedures, suggestions, methods and/or operational flowcharts disclosed in the present disclosure. The one or more processors 102 and 202 may generate signals (e.g., baseband signals) including PDUs, SDUs, messages, control information, data, or information according to the descriptions, functions, procedures, suggestions, methods and/or operational flowcharts disclosed in the present disclosure and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, suggestions, methods and/or operational flowcharts disclosed in the present disclosure.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. For example, the one or more processors 102 and 202 may be configured by a set of a communication control processor, an Application Processor (AP), an Electronic Control Unit (ECU), a Central Processing Unit (CPU), a Graphic Processing Unit (GPU), and a memory control processor.

The one or more memories 104 and 204 may be connected to the one or more processors 102 and 202 and store various types of data, signals, messages, information, programs, code, instructions, and/or commands. The one or more memories 104 and 204 may be configured by Random Access Memory (RAM), Dynamic RAM (DRAM), Read-Only Memory (ROM), electrically Erasable Programmable Read-Only Memory (EPROM), flash memory, volatile memory, non-volatile memory, hard drive, register, cash memory, computer-readable storage medium, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the descriptions, functions, procedures, suggestions, methods and/or operational flowcharts disclosed in the present disclosure, to one or more other devices. The one or more transceivers 106 and 206 may receive user data, control information, and/or radio signals/channels, mentioned in the descriptions, functions, procedures, suggestions, methods and/or operational flowcharts disclosed in the present disclosure, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices.

The one or more transceivers 106 and 206 may be connected to the one or more antennas 108 and 208. Additionally and/or alternatively, the one or more transceivers 106 and 206 may include one or more antennas 108 and 208. The one or more transceivers 106 and 206 may be adapted to transmit and receive user data, control information, and/or radio signals/channels, mentioned in the descriptions, functions, procedures, suggestions, methods and/or operational flowcharts disclosed in the present disclosure, through the one or more antennas 108 and 208. In the present disclosure, the one or more antennas 108 and 208 may be a plurality of physical antennas or a plurality of logical antennas (e.g., antenna ports).

The one or more transceivers 106 and 206 may convert received user data, control information, radio signals/channels, etc., from RF band signals into baseband signals in order to process received user data, control information, radio signals/channels, etc., using the one or more processors 102 and 202. The one or more transceivers 106 and 206 may convert the user data, control information, radio signals/channels, etc., processed using the one or more processors 102 and 202 from the base band signals into the RF band signals. To this end, the one or more transceivers 106 and 206 may include (analog) oscillators and/or filters. For example, the one or more transceivers 106 and 206 can up-convert OFDM baseband signals to OFDM signals by their (analog) oscillators and/or filters under the control of the one or more processors 102 and 202 and transmit the up-converted OFDM signals at the carrier frequency. The one or more transceivers 106 and 206 may receive OFDM signals at a carrier frequency and down-convert the OFDM signals into OFDM baseband signals by their (analog) oscillators and/or filters under the control of the one or more processors 102 and 202.

Although not shown in FIG. 2, the wireless devices 100 and 200 may further include additional components. The additional components 140 may be variously configured according to types of the wireless devices 100 and 200. For example, the additional components 140 may include at least one of a power unit/battery, an Input/Output (I/O) device (e.g., audio I/O port, video I/O port), a driving device, and a computing device. The additional components 140 may be coupled to the one or more processors 102 and 202 via various technologies, such as a wired or wireless connection.

In the implementations of the present disclosure, a UE may operate as a transmitting device in Uplink (UL) and as a receiving device in Downlink (DL). In the implementations of the present disclosure, a BS may operate as a receiving device in UL and as a transmitting device in DL. Hereinafter, for convenience of description, it is mainly assumed that the first wireless device 100 acts as the UE, and the second wireless device 200 acts as the BS. For example, the processor(s) 102 connected to, mounted on or launched in the first wireless device 100 may be adapted to perform the UE behavior according to an implementation of the present disclosure or control the transceiver(s) 106 to perform the UE behavior according to an implementation of the present disclosure. The processor(s) 202 connected to, mounted on or launched in the second wireless device 200 may be adapted to perform the BS behavior according to an implementation of the present disclosure or control the transceiver(s) 206 to perform the BS behavior according to an implementation of the present disclosure.

In the present disclosure, a BS is also referred to as anode B (NB), an eNode B (eNB), or a gNB.

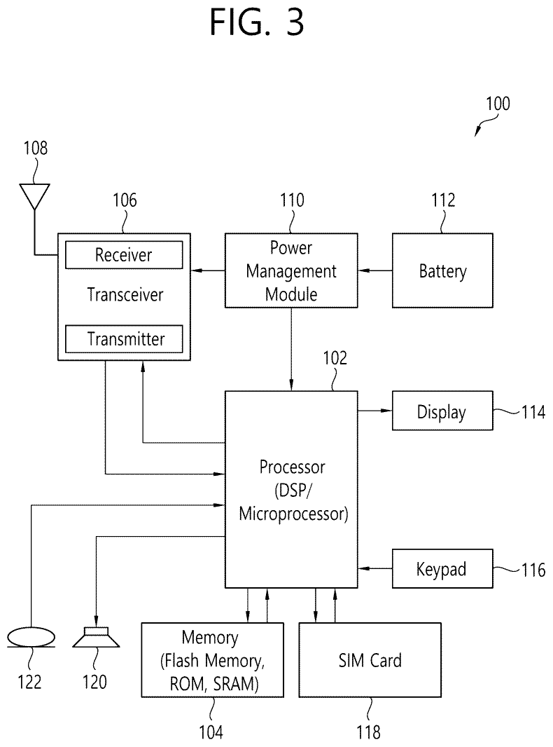

FIG. 3 shows an example of UE to which implementations of the present disclosure is applied.

Referring to FIG. 3, a UE 100 may correspond to the first wireless device 100 of FIG. 2.

A UE 100 includes a processor 102, a memory 104, a transceiver 106, one or more antennas 108, a power management module 141, a battery 142, a display 143, a keypad 144, a Subscriber Identification Module (SIM) card 145, a speaker 146, and a microphone 147.

The processor 102 may be adapted to implement the descriptions, functions, procedures, suggestions, methods and/or operational flowcharts disclosed in the present disclosure. The processor 102 may be adapted to control one or more other components of the UE 100 to implement the descriptions, functions, procedures, suggestions, methods and/or operational flowcharts disclosed in the present disclosure. Layers of the radio interface protocol may be implemented in the processor 102. The processor 102 may include ASIC, other chipset, logic circuit and/or data processing device. The processor 102 may be an application processor.

The processor 102 may include at least one of DSP, CPU, GPU, a modem (modulator and demodulator). An example of the processor 102 may be found in SNAPDRAGON™ series of processors made by Qualcomm®, EXYNOS™ series of processors made by Samsung®, A series of processors made by Apple®, HELIO™ series of processors made by MediaTek®, ATOM™ series of processors made by Intel® or a corresponding next generation processor.

The memory 104 is operatively coupled with the processor 102 and stores a variety of information to operate the processor 102. The memory 104 may include ROM, RAM, flash memory, memory card, storage medium and/or other storage device. When the embodiments are implemented in software, the techniques described herein can be implemented with modules (e.g., procedures, functions, etc.) that perform the descriptions, functions, procedures, suggestions, methods and/or operational flowcharts disclosed in the present disclosure. The modules can be stored in the memory 104 and executed by the processor 102. The memory 104 can be implemented within the processor 102 or external to the processor 102 in which case those can be communicatively coupled to the processor 102 via various means as is known in the art.

The transceiver 106 is operatively coupled with the processor 102, and transmits and/or receives a radio signal. The transceiver 106 includes a transmitter and a receiver. The transceiver 106 may include baseband circuitry to process radio frequency signals. The transceiver 106 controls the one or more antennas 108 to transmit and/or receive a radio signal.

The power management module 141 manages power for the processor 102 and/or the transceiver 106. The battery 142 supplies power to the power management module 141.

The display 143 outputs results processed by the processor 102. The keypad 144 receives inputs to be used by the processor 102. The keypad 144 may be shown on the display 143.

The SIM card 145 is an integrated circuit that is intended to securely store the International Mobile Subscriber Identity (IMSI) number and its related key, which are used to identify and authenticate subscribers on mobile telephony devices (such as mobile phones and computers). It is also possible to store contact information on many SIM cards.

The speaker 146 outputs sound-related results processed by the processor 102. The microphone 147 receives sound-related inputs to be used by the processor 102.

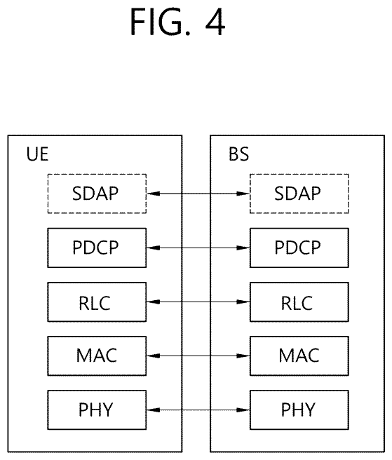

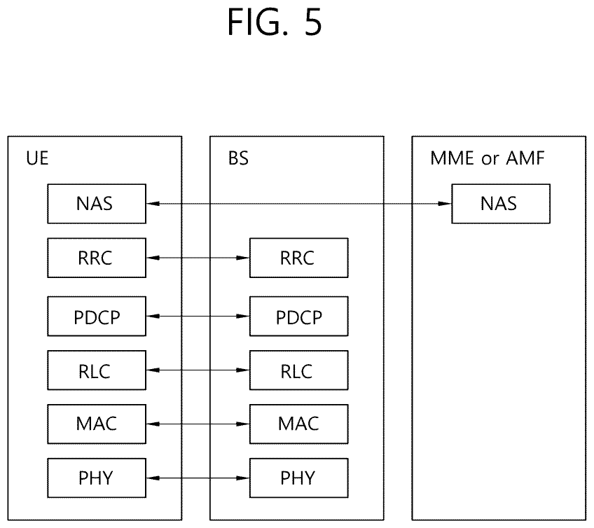

FIGS. 4 and 5 show an example of protocol stacks in a 3GPP based wireless communication system to which implementations of the present disclosure is applied.

In particular, FIG. 4 illustrates an example of a radio interface user plane protocol stack between a UE and a BS and FIG. 5 illustrates an example of a radio interface control plane protocol stack between a UE and a BS. The control plane refers to a path through which control messages used to manage call by a UE and a network are transported. The user plane refers to a path through which data generated in an application layer, for example, voice data or Internet packet data are transported. Referring to FIG. 4, the user plane protocol stack may be divided into Layer 1 (i.e., a PHY layer) and Layer 2. Referring to FIG. 5, the control plane protocol stack may be divided into Layer 1 (i.e., a PHY layer), Layer 2, Layer 3 (e.g., an RRC layer), and a non-access stratum (NAS) layer. Layer 1, Layer 2 and Layer 3 are referred to as an access stratum (AS).

In the 3GPP LTE system, the Layer 2 is split into the following sublayers: MAC, RLC, and PDCP. In the 3GPP NR system, the Layer 2 is split into the following sublayers: MAC, RLC, PDCP and SDAP. The PHY layer offers to the MAC sublayer transport channels, the MAC sublayer offers to the RLC sublayer logical channels, the RLC sublayer offers to the PDCP sublayer RLC channels, the PDCP sublayer offers to the SDAP sublayer radio bearers. The SDAP sublayer offers to 5G core network quality of service (QoS) flows.

In the 3GPP NR system, the main services and functions of the MAC sublayer include: mapping between logical channels and transport channels; multiplexing/de-multiplexing of MAC SDUs belonging to one or different logical channels into/from transport blocks (TB) delivered to/from the physical layer on transport channels; scheduling information reporting; error correction through hybrid automatic repeat request (HARQ) (one HARQ entity per cell in case of carrier aggregation (CA)); priority handling between UEs by means of dynamic scheduling; priority handling between logical channels of one UE by means of logical channel prioritization; padding. A single MAC entity may support multiple numerologies, transmission timings and cells. Mapping restrictions in logical channel prioritization control which numerology(ies), cell(s), and transmission timing(s) a logical channel can use.

Different kinds of data transfer services are offered by MAC. To accommodate different kinds of data transfer services, multiple types of logical channels are defined, i.e., each supporting transfer of a particular type of information. Each logical channel type is defined by what type of information is transferred. Logical channels are classified into two groups: control channels and traffic channels. Control channels are used for the transfer of control plane information only, and traffic channels are used for the transfer of user plane information only. Broadcast control channel (BCCH) is a downlink logical channel for broadcasting system control information, paging control channel (PCCH) is a downlink logical channel that transfers paging information, system information change notifications and indications of ongoing public warning service (PWS) broadcasts, common control channel (CCCH) is a logical channel for transmitting control information between UEs and network and used for UEs having no RRC connection with the network, and dedicated control channel (DCCH) is a point-to-point bi-directional logical channel that transmits dedicated control information between a UE and the network and used by UEs having an RRC connection. Dedicated traffic channel (DTCH) is a point-to-point logical channel, dedicated to one UE, for the transfer of user information. A DTCH can exist in both uplink and downlink. In downlink, the following connections between logical channels and transport channels exist: BCCH can be mapped to broadcast channel (BCH); BCCH can be mapped to downlink shared channel (DL-SCH); PCCH can be mapped to paging channel (PCH); CCCH can be mapped to DL-SCH; DCCH can be mapped to DL-SCH; and DTCH can be mapped to DL-SCH. In uplink, the following connections between logical channels and transport channels exist: CCCH can be mapped to uplink shared channel (UL-SCH); DCCH can be mapped to UL-SCH; and DTCH can be mapped to UL-SCH.

The RLC sublayer supports three transmission modes: transparent mode (TM), unacknowledged mode (UM), and acknowledged node (AM). The RLC configuration is per logical channel with no dependency on numerologies and/or transmission durations. In the 3GPP NR system, the main services and functions of the RLC sublayer depend on the transmission mode and include: transfer of upper layer PDUs; sequence numbering independent of the one in PDCP (UM and AM); error correction through ARQ (AM only); segmentation (AM and UM) and re-segmentation (AM only) of RLC SDUs; reassembly of SDU (AM and UM); duplicate detection (AM only); RLC SDU discard (AM and UM); RLC re-establishment; protocol error detection (AM only).

In the 3GPP NR system, the main services and functions of the PDCP sublayer for the user plane include: sequence numbering; header compression and decompression using robust header compression (ROHC); transfer of user data; reordering and duplicate detection; in-order delivery; PDCP PDU routing (in case of split bearers); retransmission of PDCP SDUs; ciphering, deciphering and integrity protection; PDCP SDU discard; PDCP re-establishment and data recovery for RLC AM; PDCP status reporting for RLC AM; duplication of PDCP PDUs and duplicate discard indication to lower layers. The main services and functions of the PDCP sublayer for the control plane include: sequence numbering; ciphering, deciphering and integrity protection; transfer of control plane data; reordering and duplicate detection; in-order delivery; duplication of PDCP PDUs and duplicate discard indication to lower layers.

In the 3GPP NR system, the main services and functions of SDAP include: mapping between a QoS flow and a data radio bearer; marking QoS flow ID (QFI) in both DL and UL packets. A single protocol entity of SDAP is configured for each individual PDU session.

In the 3GPP NR system, the main services and functions of the RRC sublayer include: broadcast of system information related to AS and NAS; paging initiated by 5GC or NG-RAN; establishment, maintenance and release of an RRC connection between the UE and NG-RAN; security functions including key management; establishment, configuration, maintenance and release of signaling radio bearers (SRBs) and data radio bearers (DRBs); mobility functions (including: handover and context transfer, UE cell selection and reselection and control of cell selection and reselection, inter-RAT mobility); QoS management functions; UE measurement reporting and control of the reporting; detection of and recovery from radio link failure; NAS message transfer to/from NAS from/to UE.

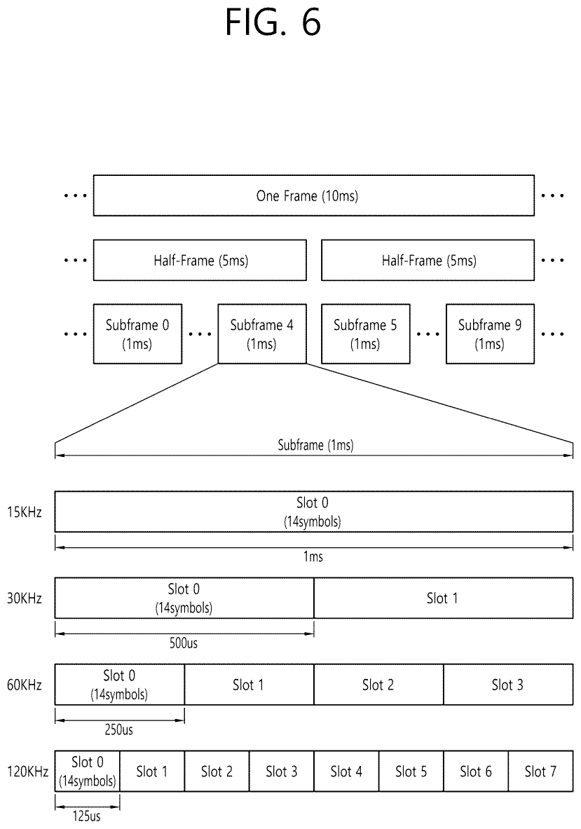

FIG. 6 shows a frame structure in a 3GPP based wireless communication system to which implementations of the present disclosure is applied.

The frame structure shown in FIG. 6 is purely exemplary and the number of subframes, the number of slots, and/or the number of symbols in a frame may be variously changed. In the 3GPP based wireless communication system, OFDM numerologies (e.g., subcarrier spacing (SCS), transmission time interval (TTI) duration) may be differently configured between a plurality of cells aggregated for one UE. For example, if a UE is configured with different SCSs for cells aggregated for the cell, an (absolute time) duration of a time resource (e.g., a subframe, a slot, or a TTI) including the same number of symbols may be different among the aggregated cells. Herein, symbols may include OFDM symbols (or CP-OFDM symbols), SC-FDMA symbols (or discrete Fourier transform-spread-OFDM (DFT-s-OFDM) symbols).

Referring to FIG. 6, downlink and uplink transmissions are organized into frames. Each frame has T_{f}=10 ms duration. Each frame is divided into two half-frames, where each of the half-frames has 5 ms duration. Each half-frame consists of 5 subframes, where the duration T_{sf} per subframe is 1ₘₛ. Each subframe is divided into slots and the number of slots in a subframe depends on a subcarrier spacing. Each slot includes 14 or 12 OFDM symbols based on a cyclic prefix (CP). In a normal CP, each slot includes 14 OFDM symbols and, in an extended CP, each slot includes 12 OFDM symbols. The numerology is based on exponentially scalable subcarrier spacing βf=2^{u}*15 kHz.

Table 3 shows the number of OFDM symbols per slot N^{slot}_{symb}, the number of slots per frame N^{frame,u}ₛₗₒₜ, and the number of slots per subframe N^{subframe,u}ₛₗₒₜ, for the normal CP, according to the subcarrier spacing βf=2^{u}*15 kHz.

TABLE 3

| u | N^{slot}_{symb} | N^{frame, u}ₛₗₒₜ | N^{subframe, u}ₛₗₒₜ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

Table 4 shows the number of OFDM symbols per slot N^{slot}_{symb}, the number of slots per frame N^{frame,u}ₛₗₒₜ, and the number of slots per subframe N^{subframe,u}ₛₗₒₜ for the extended CP, according to the subcarrier spacing βf=2^{u}*15 kHz.

TABLE 4

| u | N^{slot}_{symb} | N^{frame, u}ₛₗₒₜ | N^{subframe, u}ₛₗₒₜ |
|---|---|---|---|
| 2 | 12 | 40 | 4 |

A slot includes plural symbols (e.g., 14 or 12 symbols) in the time domain. For each numerology (e.g., subcarrier spacing) and carrier, a resource grid of N^{size,u}_{grid,x}*N^{RB}_{sc} subcarriers and N^{subframe,u}_{symb} OFDM symbols is defined, starting at common resource block (CRB) N^{start,u}_{grid} indicated by higher-layer signaling (e.g., RRC signaling), where N^{size,u}_{grid,x} is the number of resource blocks (RBs) in the resource grid and the subscript x is DL for downlink and UL for uplink. N^{RB}_{sc} is the number of subcarriers per RB. In the 3GPP based wireless communication system, N^{RB}_{sc} is 12 generally. There is one resource grid for a given antenna port p, subcarrier spacing configuration u, and transmission direction (DL or UL). The carrier bandwidth N^{size,u}_{grid} for subcarrier spacing configuration u is given by the higher-layer parameter (e.g., RRC parameter). Each element in the resource grid for the antenna port p and the subcarrier spacing configuration u is referred to as a resource element (RE) and one complex symbol may be mapped to each RE. Each RE in the resource grid is uniquely identified by an index k in the frequency domain and an index l representing a symbol location relative to a reference point in the time domain. In the 3GPP based wireless communication system, an RB is defined by 12 consecutive subcarriers in the frequency domain. In the 3GPP NR system, RBs are classified into CRBs and physical resource blocks (PRBs). CRBs are numbered from 0 and upwards in the frequency domain for subcarrier spacing configuration u. The center of subcarrier 0 of CRB 0 for subcarrier spacing configuration u coincides with ‘point A’ which serves as a common reference point for resource block grids. In the 3GPP NR system, PRBs are defined within a bandwidth part (BWP) and numbered from 0 to N^{size}_{BWP,i}−1, where i is the number of the bandwidth part. The relation between the physical resource block n_{PRB} in the bandwidth part i and the common resource block n_{CRB} is as follows: n_{PRB}=n_{CRB}+N^{size}_{BWP,i}, where N^{size}_{BWP,i} is the common resource block where bandwidth part starts relative to CRB 0. The BWP includes a plurality of consecutive RBs. A carrier may include a maximum of N (e.g., 5) BWPs. A UE may be configured with one or more BWPs on a given component carrier. Only one BWP among BWPs configured to the UE can active at a time. The active BWP defines the UE's operating bandwidth within the cell's operating bandwidth.

In the present disclosure, the term “cell” may refer to a geographic area to which one or more nodes provide a communication system, or refer to radio resources. A “cell” as a geographic area may be understood as coverage within which a node can provide service using a carrier and a “cell” as radio resources (e.g., time-frequency resources) is associated with bandwidth which is a frequency range configured by the carrier. The “cell” associated with the radio resources is defined by a combination of downlink resources and uplink resources, for example, a combination of a DL component carrier (CC) and a UL CC. The cell may be configured by downlink resources only, or may be configured by downlink resources and uplink resources. Since DL coverage, which is a range within which the node is capable of transmitting a valid signal, and UL coverage, which is a range within which the node is capable of receiving the valid signal from the UE, depends upon a carrier carrying the signal, the coverage of the node may be associated with coverage of the “cell” of radio resources used by the node. Accordingly, the term “cell” may be used to represent service coverage of the node sometimes, radio resources at other times, or a range that signals using the radio resources can reach with valid strength at other times.

In CA, two or more CCs are aggregated. A UE may simultaneously receive or transmit on one or multiple CCs depending on its capabilities. CA is supported for both contiguous and non-contiguous CCs. When CA is configured, the UE only has one RRC connection with the network. At RRC connection establishment/re-establishment/handover, one serving cell provides the NAS mobility information, and at RRC connection re-establishment/handover, one serving cell provides the security input. This cell is referred to as the primary cell (PCell). The PCell is a cell, operating on the primary frequency, in which the UE either performs the initial connection establishment procedure or initiates the connection re-establishment procedure. Depending on UE capabilities, secondary cells (SCells) can be configured to form together with the PCell a set of serving cells. An SCell is a cell providing additional radio resources on top of special cell (SpCell). The configured set of serving cells for a UE therefore always consists of one PCell and one or more SCells. For dual connectivity (DC) operation, the term SpCell refers to the PCell of the master cell group (MCG) or the primary SCell (PSCell) of the secondary cell group (SCG). An SpCell supports PUCCH transmission and contention-based random access, and is always activated. The MCG is a group of serving cells associated with a master node, comprised of the SpCell (PCell) and optionally one or more SCells. The SCG is the subset of serving cells associated with a secondary node, comprised of the PSCell and zero or more SCells, for a UE configured with DC. For a UE in RRC_CONNECTED not configured with CA/DC, there is only one serving cell comprised of the PCell. For a UE in RRC_CONNECTED configured with CA/DC, the term “serving cells” is used to denote the set of cells comprised of the SpCell(s) and all SCells. In DC, two MAC entities are configured in a UE: one for the MCG and one for the SCG.

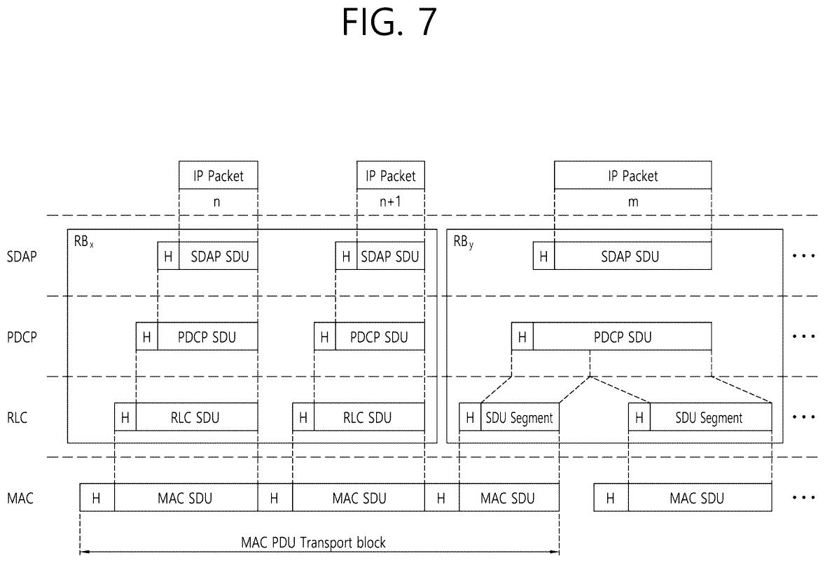

FIG. 7 shows a data flow example in the 3GPP NR system to which implementations of the present disclosure is applied.

Referring to FIG. 7, “RB” denotes a radio bearer, and “H” denotes a header. Radio bearers are categorized into two groups: DRBs for user plane data and SRBs for control plane data. The MAC PDU is transmitted/received using radio resources through the PHY layer to/from an external device. The MAC PDU arrives to the PHY layer in the form of a transport block.

In the PHY layer, the uplink transport channels UL-SCH and RACH are mapped to their physical channels physical uplink shared channel (PUSCH) and physical random access channel (PRACH), respectively, and the downlink transport channels DL-SCH, BCH and PCH are mapped to physical downlink shared channel (PDSCH), physical broadcast channel (PBCH) and PDSCH, respectively. In the PHY layer, uplink control information (UCI) is mapped to physical uplink control channel (PUCCH), and downlink control information (DCI) is mapped to physical downlink control channel (PDCCH). A MAC PDU related to UL-SCH is transmitted by a UE via a PUSCH based on an UL grant, and a MAC PDU related to DL-SCH is transmitted by a BS via a PDSCH based on a DL assignment.

Hereinafter, contents related to a multi-universal subscriber identity module (MUSIM) is described.

Multi-USIM devices (e.g., MUSIM device 810) have been more and more popular in different countries. The user may have both a personal and a business subscription in one device or have two personal subscriptions in one device for different services.

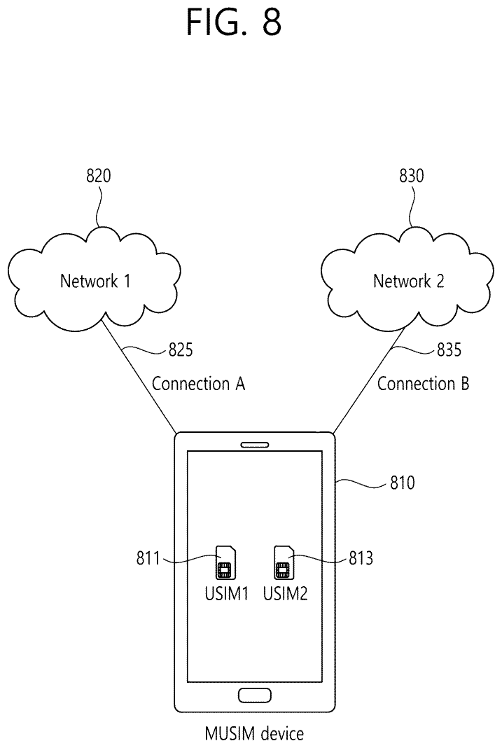

FIG. 8 shows an example of a wireless environment in which a MUSIM device operates according to an embodiment of the present disclosure.

Referring to FIG. 8, MUSIM device 810 (or, MUSIM UE 810) may have a plurality of universal subscriber identity modules (USIMs)—USIM1 811 (or, USIM A 811) and USIM2 813 (USIM B 813). The MUSIM device 810 may register to a network 1 (or, network A) 820 based on subscription information in the USIM1 811 to obtain a connection A 825 between the network 1 820 and the MUSIM device 810. The MSUIM device 810 may also register to a network 2 (or, network B) 830 based on subscription information in the USIM2 813 to obtain a connection B 835 between the network 2 830 and the MUSIM device 810. The MUSIM device 810 may use the USIM1 811 to perform a communication with the network 1 820 over the connection A 825, and use the USIM2 813 to perform a communication with the network 2 830 over the connection B 835.

In a wireless environment in which a MUSIM device operates, the following properties may hold:
Each registration from the USIMS of a MUSIM device may be handled independently.
Each registered USIM in the MUSIM device may be associated with a dedicated international mobile equipment identity (IMEI)/permanent equipment identifier (PEI).
A MUSIM UE may be connected with i) evolved packet system (EPS) on one USIM and 5G system (5GS) on the other USIM; ii) EPS on both USIMs; or iii) 5GS on both USIMs.
A MUSIM UE may be a single reception (RX)/dual RX/single transmission (TX)/Dual TX UE. Single RX may allow the MUSIM UE to receive traffic from only one network at one time. Dual RX may allow the MUSIM UE to simultaneously receive traffic from two networks. Single TX may allow the MUSIM UE to transmit traffic to one network at one time. Dual TX may allow the MUSIM UE to simultaneously transmit traffic to two networks. The terms single RX/TX and Dual RX/TX do not refer to a device type. A single UE may, as an example, use Dual TX in some cases but Single TX in other case.
If/when the multiple USIMs in the MUSIM device are served by different serving networks, network coordination between the serving networks may not be required.
A MUSIM device with different USIMs may be camping with all USIMs on the same serving network RAN node, or the MUSIM device may be camping on different serving networks RAN nodes.
USIMs may belong to same or different operators. Coordination between involved operators may not be required.
USIM may be a physical SIM or embedded SIM (eSIM).

While actively communicating with a first system/network, a MUSIM UE may need to periodically monitor a second system/network (e.g. to synchronize, read the paging channel, perform measurements, or read the system information). The periodical activity on the second system may or may not have performance impact on the first system the UE is communicating with, depending on the UE implementation (i.e., single reception (Rx) or dual Rx).

In some cases, the UE equipped with different USIMs may have paging collisions which results in missed paging. When the UE receives a page in the second system while actively communicating with the first system, the UE may need to decide whether the UE should respond to this paging or not. When the UE decides to respond to the paging in the second system, the UE may need to stop the current activity in the first system. For example, the first system may suspend or release the ongoing connection with the UE.

For MUSIM operation, a MUSIM device in RRC_CONNECTED state in Network A may have to switch from Network A to Network B. For example, the MUSIM device in RRC_CONNECTED state in Network A may perform a network switching from Network A to Network B (or, perform SIM switching from a SIM associated with Network A to a SIM associated with Network B) and establish a connection with Network B (and enter RRC_CONNECTED in Network B), based on receiving a paging from Network B. Herein, Network A may be NR and Network B can either be E-UTRA or NR. Before switching from Network A, a MUSIM device should notify Network A to either leave RRC_CONNECTED state, or be kept in RRC_CONNECTED state in Network A while temporarily switching to Network B.

For example, when configured to do so, a MUSIM device can signal to the Network A a preference to leave RRC_CONNECTED state by using RRC or NAS signalling. After sending a preference to leave RRC_CONNECTED state by using RRC signalling, if the MUSIM device does not receive an RRCRelease message from the Network A within a certain time period (configured by the Network A), the MUSIM device can enter RRC_IDLE state in Network A.

For example, when configured to do so, a MUSIM device can signal to the Network A a preference to be temporarily switching to Network B while remaining in RRC_CONNECTED state in Network. This is indicated by scheduling gaps preference. This preference can include information for setup or release of gap(s). The Network A can configure at most 4 gap patterns for MUSIM purpose: three periodic gaps and a single aperiodic gap. The Network A should always provide at least one of the requested gap pattern or no gaps. Network may provide an alternative gap pattern instead of the one requested by the UE.

In the present disclosure, if UE's capability does not support simultaneously performing operations on a first radio resource and operations on a second radio resource, it may be referred to as there is a capability conflict between the first radio resource and the second radio resource, and/or the first radio resource conflicts the second radio resource. The capability conflict may occur in MUSIM operation, for example, between the first radio resource in network A and the second radio resource in network B.

Hereinafter, mobility is described.

In the disclosure, ‘Mobility’ refers to a procedure for i) changing a PCell of a UE (i.e., handover or PCell change), ii) changing a PSCell of a UE (i.e., SN change or PSCell change), and/or iii) adding a PSCell for a UE (i.e., SN addition or PSCell addition). Therefore, the mobility may comprise at least one of a handover, an SN change or an SN addition. In other words, the mobility may comprise at least one of PCell change, PSCell change or PSCell addition. Throughout the disclosure, performing a mobility to a target cell may refer to applying a mobility command of the target cell or applying a target cell configuration for the target cell in the mobility command of the target cell. The target cell configuration for the target cell may comprise RRC reconfiguration (i.e., RRCReconfiguration message) including RRC reconfiguration parameters associated with the mobility to the target cell. Further, RRC reconfiguration and RRC connection reconfiguration may be used interchangeably.

In the disclosure, the target cell configuration may also be referred to as candidate cell configuration. The candidate cell configuration may comprise reconfigurationWithSync, which comprise parameters for the synchronous reconfiguration to the target SpCell. For example, the reconfigurationWithSync may comprise at least one of a new UE-identity (i.e., a kind of RNTI value), timer T304, spCellConfigCommon, rach-ConfigDedicated or smtc. The spCellConfigCommon may comprise ServingCellConfigCommon which is used to configure cell specific parameters of SpCell. The rach-ConfigDedicated may indicate a random access configuration to be used for a reconfiguration with sync (e.g., mobility). The smtc may indicate a synchronization signal/physical broadcast channel (SS/PBCH) block periodicity/offset/duration configuration of target cell for PSCell change, PCell change and/or PSCell addition. The SS/PBCH block may be simply referred to as synchronization signal block (SSB).

‘SN mobility’ refers to a procedure for i) changing a PSCell of a UE (i.e., SN change or PSCell change), and/or ii) adding a PSCell for a UE (i.e., SN addition or PSCell addition). Therefore, the SN mobility may comprise at least one of an SN change or an SN addition. In other words, the SN mobility may comprise at least one of PSCell change or PSCell addition. Throughout the disclosure, performing an SN mobility to a target cell may refer to applying an SN mobility command of the target cell or applying a target cell configuration for the target cell in the SN mobility command of the target cell. The target cell configuration for the target cell may comprise RRC reconfiguration (i.e., RRCReconfiguration message) including RRC reconfiguration parameters associated with the SN mobility to the target cell. The SN mobility may be a kind of a mobility. The SN mobility command may comprise a SN change command for performing SN change, or SN addition command for performing SN addition.

‘Conditional mobility’ refers to a mobility that is performed to a target cell which fulfils an execution condition among a plurality of candidate target cells. Throughout the disclosure, performing a conditional mobility to a target cell may refer to applying a conditional mobility command of a target cell which fulfils a mobility condition for the target cell among a plurality of candidate target cells or applying a target cell configuration for the target cell in the conditional mobility command of the target cell which fulfils a mobility condition for the target cell among the plurality of candidate target cells. The target cell configuration for the target cell may comprise RRC reconfiguration (i.e., RRCReconfiguration message) including RRC reconfiguration parameters associated with the conditional mobility to the target cell. Conditional mobility may comprise a conditional handover (i.e., conditional PCell change/CHO), a conditional SN change (i.e., conditional PSCell change (CPC)), and/or conditional SN addition (i.e., conditional PSCell addition (CPA)). The conditional PSCell addition/change (CPAC) may comprise the CPC and/or the CPA.

‘Mobility condition for a target cell’ refers to an execution condition for a mobility to the target cell. That is, the mobility condition for a target cell refers to a condition that should be fulfilled for executing a mobility to the target cell. Mobility condition may comprise at least one of event A3 condition (i.e., mobility condition for event A3/condEventA3), event A4 condition (i.e., mobility condition for event A4/condEventA4), or event A5 condition (i.e., mobility condition for event A5/condEventA5). The event A3 condition may comprise at least one of an offset value, or a time-to-trigger (TTT). The event A4 condition may comprise at least one of a target cell threshold, or a TTT. The event A5 condition may comprise at least one of a serving cell threshold, a target cell threshold, or a TTT. The mobility condition for an event may be fulfilled if/when an entering condition (or, also referred to as entry condition) for the event is fulfilled for at least the TTT. For example, the entering condition for event A3 may be fulfilled if a signal quality for a target cell is better than that for a serving cell more than or equal to the offset value. An entering condition for event A4 may be fulfilled if a signal quality for a target cell is better than the target cell threshold. An entering condition for event A5 may be fulfilled if a signal quality for a target cell is better than the target cell threshold and a signal quality for a serving cell is lower than the serving cell threshold. The mobility condition may also be referred to as a triggering condition/conditional execution condition/conditional mobility execution condition (e.g., CHO execution condition).

‘SN mobility condition for a target cell’ refers to an execution condition for an SN mobility (i.e., SN addition or SN change) to the target cell. That is, the SN mobility condition for a target cell refers to a condition that should be fulfilled for executing an SN mobility to the target cell. SN mobility condition for a target cell may be classified as:
i) SN addition condition for a target cell, which refers to an execution condition for an SN addition of the target cell; or
ii) SN change condition for a target cell, which refers to an execution condition for an SN change to the target cell.

The mobility condition may inform at least one measurement ID. For example, the mobility condition may inform at most 2 measurement IDs. If a mobility condition of a target cell informs a measurement ID which is related to a report configuration, the mobility condition of the target cell may be a condition (e.g., event A3/A4/A5 condition) specified/indicated by a conditional reconfiguration triggering configuration (i.e., CondTriggerConfig) in the report configuration. The conditional reconfiguration triggering configuration may further specify/indicate a type of reference signal to measure for evaluating the mobility condition.

For CHO, intra-SN CPC and SN initiated inter-SN CPC, the mobility command may comprise at least one of event A3 condition or event A5 condition. For CPA and MN-initiated inter-SN CPC, the mobility condition may comprise event A4 condition.

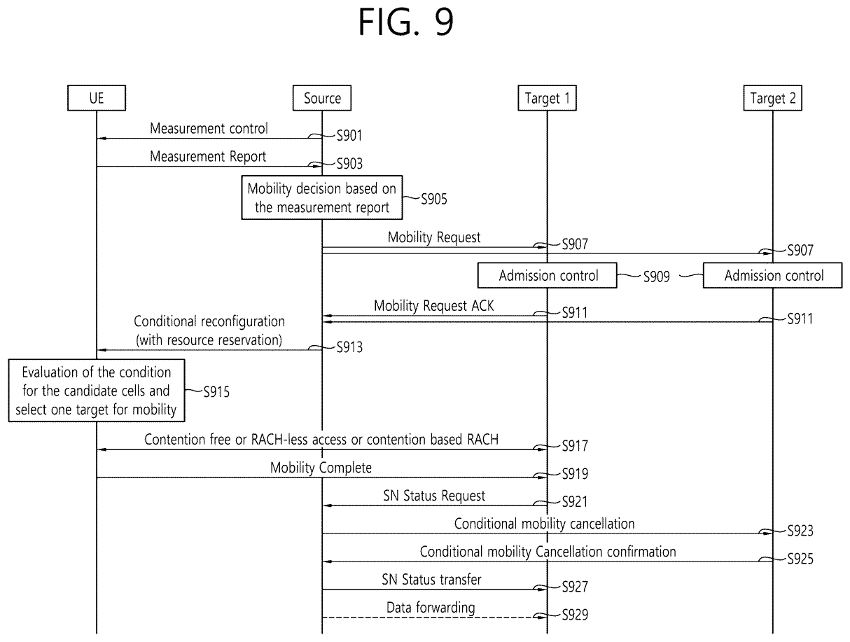

FIG. 9 shows an example of a conditional mobility procedure to which technical features of the present disclosure can be applied. The steps illustrated in FIG. 9 can also be applied to a conditional handover procedure, conditional SN addition procedure and/or conditional SN change procedure.

Referring to FIG. 9, in step S901, the source cell may transmit measurement control message to the UE. The measurement control message may comprise a measurement configuration including a list of measurement configurations, and each measurement configuration in the list includes a measurement identity (ID), the corresponding measurement object and the corresponding report configuration.

In step S903, the UE may transmit a measurement report message to the source cell. The measurement report message may comprise a result of measurement on neighbor cell(s) around the UE which can be detected by the UE. The UE may generate the measurement report message according to a measurement configuration and/or measurement control information in the measurement control message received in step S901.

In step S905, the source cell may make a mobility decision based on the measurement report. For example, the source cell may make a mobility decision and determine candidate target cells (e.g., target cell 1 and target cell 2) for mobility among neighbor cells around the UE based on a result of measurement (e.g., signal quality, reference signal received power (RSRP), reference signal received quality (RSRP)) on the neighbor cells.

In step S907, the source cell may transmit mobility request messages to the target cell 1 and the target cell 2 which are determined in step S905. That is, the source cell may perform mobility preparation with the target cell 1 and the target cell 2. The mobility request message may comprise necessary information to prepare the mobility at the target side (e.g., target cell 1 and target cell 2).

In step S909, each of the target cell 1 and the target cell 2 may perform an admission control based on information included in the mobility request message. The target cell may configure and reserve the required resources (e.g., C-RNTI and/or RACH preamble). The AS-configuration to be used in the target cell can either be specified independently (i.e. an “establishment”) or as a delta compared to the AS-configuration used in the source cell (i.e. a “reconfiguration”).

In step S911, the target cell and the target cell 2 may transmit a mobility request acknowledge (ACK) message to the source cell. The mobility request ACK message may comprise target cell configuration (i.e., RRCReconfiguration message including ReconfigurationWithSync) including information on resources reserved and prepared for a mobility. For example, the mobility request ACK message may comprise a transparent container to be sent to the UE as an RRC message (i.e., RRCReconfiguration message/target cell configuration) to perform the mobility. The container/target cell configuration/RRCReconfiguration message may include a new C-RNTI, target gNB security algorithm identifiers for the selected security algorithms, access configuration such as dedicated RACH resources including dedicated preamble, and/or possibly some other parameters i.e., access parameters, SIBs. If RACH-less mobility is configured, the container may include timing adjustment indication and optionally a pre-allocated uplink grant. The mobility request ACK message may also include RNL/TNL information for forwarding tunnels, if necessary. As soon as the source cell receives the mobility request ACK message, or as soon as the transmission of the conditional mobility command is initiated in the downlink, data forwarding may be initiated.

In step S913, the source cell may transmit aRRCReconfiguration message including a conditional reconfiguration to the UE. The conditional reconfiguration may be also referred to as (or, may comprise) conditional handover (CHO) configuration and/or a conditional mobility command (e.g., CHO command). The conditional reconfiguration may comprise a list of conditional reconfigurations/conditional mobility commands, including a conditional reconfiguration/conditional mobility command for each of the candidate target cells (e.g., target cell 1, target cell 2). For example, the conditional reconfiguration may comprise a conditional reconfiguration/conditional mobility command for the target cell 1, and a conditional reconfiguration/conditional mobility command for the target cell 2. The conditional reconfiguration for the target cell 1 may comprise an index/identifier identifying the corresponding conditional reconfiguration, a mobility condition for the target cell 1, and/or a target cell configuration for the target cell 1. The target cell configuration for the target cell 1 (i.e., RRCReconfiguration message including ReconfigurationWithSync for the target cell 1 received from the target cell 1 in step S911) may comprise RRC reconfiguration parameters associated with a mobility to the target cell 1, including information on resources reserved and prepared for the mobility to the target cell 1. Similarly, the conditional reconfiguration for the target cell 2 may comprise an index/identifier identifying the corresponding conditional reconfiguration, a mobility condition for the target cell 2, and a target cell configuration for the target cell 2. The target cell configuration for the target cell 2 (i.e., RRCReconfiguration message including ReconfigurationWithSync for the target cell 2 received from the target cell 2 in step S911) may comprise RRC reconfiguration parameters associated with a mobility to the target cell 2, including information on resources reserved and prepared for the mobility to the target cell 2.

For example, the conditional reconfiguration (i.e., ConditionalReconfiguration) may comprise a list of conditional mobility commands/conditional reconfigurations (i.e., CondReconfigToAddModList), as shown in table 5:

```
TABLE 5
  ConditionalReconfiguration-r16 ::= SEQUENCE {
    attemptCondReconfig-r16 ENUMERATED {true}
OPTIONAL, -- Cond CHO
    condReconfigToRemoveList-r16 CondReconfigToRemoveList-r16
OPTIONAL, -- Need N
    condReconfigToAddModList-r16 CondReconfigToAddModList-
r16 OPTIONAL, -- Need N
    ...
  }
  CondReconfigToRemoveList-r16  ::= SEQUENCE (SIZE (1..
maxNrofCondCells-r16)) OF CondReconfigId-r16
```

In table 5, if attemptCondReconig is present, the UE shall perform conditional reconfiguration if selected cell is a target candidate cell and it is the first cell selection after failure. The CondReconfigToAddModList may be a list of the configuration (e.g., list of mobility commands) ofcandidate SpCells to be added or modified for CHO, CPA or CPC. The condReconfigToRemoveList may be a list of the configuration (e.g., list of mobility commands) of candidate SpCells to be removed. Each conditional reconfiguration/mobility command (i.e., CondReconfigToAddMod) in the CondReconfigToAddModDist may comprise an index/identifier identifying the corresponding conditional reconfiguration (i.e., condReconfigId), a mobility condition (i.e., condExecutionCond), and a target cell configuration (i.e., condRRCReconfig) as shown in table 6:

TABLE 6
CondReconfigToAddModList-r16 ::= SEQUENCE (SIZE (1.. maxNrofCondCells-
r16)) OF CondReconfigToAddMod-r16

| | |
|---|---|
| CondReconfigToAddMod-r16 ::= | SEQUENCE { |
| condReconfigId-r16 | CondReconfigId-r16, |
| condExecutionCond-r16 | SEQUENCE (SIZE (1..2)) OF MeasId |

OPTIONAL, -- Need M

| | |
|---|---|
| condRRCReconfig-r16 | OCTET STRING (CONTAINING |

```
RRCReconfiguration) OPTIONAL, -- Cond condReconfigAdd
    ...,
    [[
```

| | |
|---|---|
| condExecutionCondSCG-r17 | OCTET STRING (CONTAINING |

```
CondReconfigExecCondSCG-r17) OPTIONAL -- Need M
    ]]
  }
  CondReconfigExecCondSCG-r17 ::= SEQUENCE (SIZE (1..2)) OF MeasId
```

In table 6: The condExecutionCond may be the execution condition that needs to be fulfilled in order to trigger the execution of a conditional reconfiguration for CHO, CPA, intra-SN CPC without MN involvement or MN initiated inter-SN CPC. When configuring 2 triggering events (Meas Ids) for a candidate cell, the network ensures that both refer to the same measObject. For CPA and for MN-initiated inter-SN CPC, the network only indicates MeasId(s) associated with condEventA4. For intra-SN CPC, the network only indicates MeasId(s) associated with condEventA3 or condEventA5.
The condExecutionCondSCG contains execution condition that needs to be fulfilled in order to trigger the execution of a conditional reconfiguration for SN initiated inter-SN CPC. The Meas Ids refer to the measConfig associated with the SCG. When configuring 2 triggering events (Meas Ids) for a candidate cell, network ensures that both refer to the same measObject. For each condReconfigId, the network always configures either condExecutionCond or condExecutionCondSCG (not both). The network only indicates MeasId(s) associated with condEventA3 or condEventA5.
The condRRCReconfig may be the RRCReconfiguration message to be applied when the condition(s) are fulfilled.

In step S915, the UE may perform an evaluation of the mobility condition for the candidate target cells (e.g., target cell 1, target cell 2) and select a target cell for a mobility among the candidate target cells. For example, the UE may perform measurements on the candidate target cells, and determine whether a candidate target cell fulfils a mobility condition for the candidate target cell among the candidate target cells based on a result of the measurements on the candidate target cells. Or, the UE may determine whether the target cell/measurement result for the target cell fulfils the mobility condition of the target cell. If the UE identifies that the target cell 1 fulfils a mobility condition for the target cell 1, the UE may select the target cell 1 as a target cell for the mobility. Then, the UE may apply the target cell configuration for the selected target cell (i.e., execute conditional reconfiguration for the selected target cell/initiate conditional mobility to the selected target cell) and/or initiate a random access procedure to the selected target cell. Upon applying the target cell configuration for the selected target cell and/or initiating the random access procedure to the selected target cell, the UE may start T304 timer.

In step S917, the UE may perform conditional mobility to the selected target cell while the T304 timer is running. For example, the UE may transmit a random access preamble to the target cell 1, and receive a random access response comprising an uplink grant from the target cell 1. If RACH-less mobility is configured, the uplink grant may be provided in step S913.

In step S919, the UE may transmit a mobility complete message (i.e., RRCReconfigurationComplete message) to the target cell 1. When the UE has successfully accessed the target cell 1 (or, received uplink grant when RACH-less mobility is configured), the UE may transmit, based on the received uplink grant, a mobility complete message comprising a C-RNTI to confirm the mobility, along with uplink buffer status report, whenever possible, to the target cell 1 to indicate that the mobility procedure is completed for the UE. The target cell 1 may verify the C-RNTI transmitted in the mobility complete message.

Upon successful completion of the conditional mobility to the target cell (i.e., upon successful completion of the random access procedure to the target cell and/or upon transmitting the mobility complete message to the target cell), the UE may stop the T304 timer. On the other hand, when the T304 timer is not stopped and expires, the UE may detect a mobility failure/conditional mobility failure, and initiate a failure recovery procedure.

In step S921, the target cell 1 may transmit a sequence number (SN) status request message to the source cell. The target cell 1 may request the source cell to inform the target cell 1 of a SN of a packet the target cell 1 has to transmit after the mobility, via the SN status request message.

In step S923, the source cell may transmit a conditional mobility cancellation message to the target cell 2 which is not selected as a target cell for a mobility among the candidate target cells. After receiving the conditional mobility cancellation message, the target cell 2 may release resources that are reserved in case of a mobility.

In step S925, the target cell 2 may transmit a conditional mobility cancellation confirmation message to the source cell, as a response for the conditional mobility cancellation message. The conditional mobility cancellation confirmation message may inform that the target cell 2 has released resources reserved in case of a mobility.

In step S927, the source cell may transmit a SN status transfer message to the target cell 1, as a response for the SN status request message. The SN status transfer message may inform the target cell 1 of a SN of a packet the target cell 1 has to transmit after the mobility.

In step S929, the source cell may perform a data forwarding to the target cell 1. For example, the source cell may forward data received from a core network to the target cell 1 so that the target cell 1 can now transmit the data to the UE.

For conditional reconfiguration/conditional mobility, the network configures the UE with one or more candidate target SpCells in the conditional reconfiguration. The UE evaluates the condition of each configured candidate target SpCell. The UE applies the conditional reconfiguration associated with one of the target SpCells which fulfils associated execution condition. The network provides the configuration parameters for the target SpCell in the ConditionalReconfiguration IE.

In NR-DC, the UE may receive two independent conditionalReconfiguration:
a conditionalReconfiguration associated with MCG, that is included in the RRCReconfiguration message received via SRB1; and
a conditionalReconfiguration, associated with SCG, that is included in the RRCReconfiguration message received via SRB3, or, alternatively, included within a RRCReconfiguration message embedded in a RRCReconfiguration message received via SRB1.

In this case:
the UE maintains two independent VarConditionalReconfig, one associated with each conditionalReconfiguration;
the UE independently performs conditional reconfiguration/conditional mobility for each conditionalReconfiguration and the associated VarConditionalReconfig, unless explicitly stated otherwise;
the UE performs measurements for the VarConditionalReconfig associated with the same cell group like the measConfig.

In EN-DC, the VarConditionalReconfig is associated with the SCG.

In NE-DC and when no SCG is configured, the VarConditionalReconfig is associated with the MCG.

The UE performs the following actions based on a received ConditionalReconfiguration IE:
1>if the ConditionalReconfiguration contains the condReconfigToRemoveList:
2>perform conditional reconfiguration removal procedure;
1>if the ConditionalReconfiguration contains the condReconfigToAddModList:
2>perform conditional reconfiguration addition.

For conditional reconfiguration removal, the UE shall:
1>for each condReconfigId value included in the condReconfigToRemoveList that is part of the current UE conditional reconfiguration in VarConditionalReconfig:
2>remove the entry with the matching condReconfigId from the VarConditionalReconfig.

The UE does not consider the message as erroneous if the condReconfigToRemoveList includes any condReconfigId value that is not part of the current UE configuration.

For conditional reconfiguration addition/modification, for each condReconfigId received in the condReconfigToAddModList IE the UE shall:
1>if an entry with the matching condReconfigId exists in the condReconfigToAddModList within the VarConditionalReconfig:
2>if the entry in condReconfgToAddModList includes an condExecutionCond or condExecutionCondSCG;
3>replace condExecutionCond or condExecutionCondSCG within the VarConditionalReconfig with the value received for this condReconfigId;
2>if the entry in condReconfigToAddModList includes an condRRCReconfig;
3>replace condRRCReconfig within the VarConditionalReconfig with the value received for this condReconfigId;
1>else:
2>add a new entry for this condReconfigId within the VarConditionalReconfig;
1>perform conditional reconfiguration evaluation.

For conditional reconfiguration evaluation, the UE shall:
1>for each condReconfigId within the VarConditionalReconfig:
2>if the RRCReconfiguration within condRRCReconfig includes the masterCellGroup including the reconfigurationWithSync:
3>consider the cell which has a physical cell identity matching the value indicated in the ServingCellConfigCommon included in the reconfigurationWithSync within the masterCellGroup in the received condRRCReconfig to be applicable cell;
2>else if the RRCReconfiguration within condRRCReconfig includes the secondaryCellGroup including the reconfigurationWithSync:
3>consider the cell which has a physical cell identity matching the value indicated in the ServingCellConfigCommon included in the reconfigurationWithSync within the secondaryCellGroup within the received condRRCReconfig to be applicable cell;
2>if condExecutionCondSCG is configured:
3>in the remainder of the procedure, consider each measId indicated in the condExecutionCondSCG as a measId in the VarMeasConfig associated with the SCG measConfig;
2>if condExecutionCond is configured:
3>if it is configured via SRB3 or configured within nr-SCG or within nr-SecondaryCellGroupConfig:
4>in the remainder of the procedure, consider each measId indicated in the condExecutionCond as a measId in the VarMeasConfig associated with the SCG measConfig;
3>else:
4>in the remainder of the procedure, consider each measId indicated in the condExecutionCond as a measId in the VarMeasConfig associated with the MCG measConfig;
2>for each measId included in the measIdList within VarMeasConfig indicated in the condExecutionCond or condExecutionCondSCG associated to condReconfigId:
3>if the condEventId is associated with condEventA3, condEventA4 or condEventA5, and if the entry condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4>consider the event associated to that measId to be fulfilled;
3>if the measId for this event associated with the condReconfigId has been modified; or
3>if the condEventId is associated with condEventA3, condEventA4 or condEventA5, and if the leaving condition(s) applicable for this event associated with the condReconfigId, i.e. the event corresponding with the condEventId(s) of the corresponding condTriggerConfig within VarConditionalReconfig, is fulfilled for the applicable cells for all measurements after layer 3 filtering taken during the corresponding timeToTrigger defined for this event within the VarConditionalReconfig:
4>consider the event associated to that measId to be not fulfilled;
2>if event(s) associated to all measId(s) within condTriggerConfig for a target candidate cell within the stored condRRCReconfig are fulfilled:
3>consider the target candidate cell within the stored condRRCReconfig, associated to that condReconfigId, as a triggered cell;
3>initiate the conditional reconfiguration execution.

Up to 2 MeasId can be configured for each condReconfigId. The conditional reconfiguration event of the 2 MeasId may have the same or different event conditions, triggering quantity, time to trigger, and triggering threshold.

For conditional reconfiguration evaluation of SN initiated inter-SN CPC for EN-DC, the UE shall:
1>for each condReconfigurationId within the VarConditionalReconfiguration:
2>for each measId included in the measIdList within VarMeasConfig indicated in the CondReconfigExecCondSCG contained in the triggerConditionSN associated to the condReconfigurationId:
3>if the entry condition(s) applicable for the event associated with that measId, is fulfilled for the applicable cells for all measurements after layer 3 filtering taken during the corresponding timeToTrigger defined for this event associated with that measId:
4>consider this event to be fulfilled;
3>if the measId for this event has been modified; or
3>if the leaving condition(s) applicable for this event associated with that measId, is fulfilled for the applicable cells for all measurements after layer 3 filtering taken during the corresponding timeToTrigger defined for this event associated with that measId:
4>consider this event associated to that measId to be not fulfilled;
2>if trigger conditions for all events associated with the measId(s) indicated in the CondReconfigExecCondSCG contained in the triggerConditionSN are fulfilled:
3>consider the target cell candidate within the RRCReconfiguration message contained in nr-SecondaryCellGroupConfig in the RRCConnectionReconfiguration message, contained in the stored condReconfigurationToApply, associated to that condReconfigurationId, as a triggered cell;
3>initiate the conditional reconfiguration execution.

For conditional reconfiguration execution, the UE shall:
1>if more than one triggered cell exists:
2>select one of the triggered cells as the selected cell for conditional reconfiguration execution;
1>else:
2>consider the triggered cell as the selected cell for conditional reconfiguration execution;
1>for the selected cell of conditional reconfiguration execution:
2>apply the stored condRRCReconfig of the selected cell and perform actions as RRCReconfiguration is received by the UE (e.g., random access procedure).

If multiple NR cells are triggered in conditional reconfiguration execution, it is up to UE implementation which one to select, e.g. the UE considers beams and beam quality to select one of the triggered cells for execution.

Meanwhile, the Multi-USIM (MUSIM) function may support a scenario where the UE in both SIM A (i.e., network A) and SIM B (i.e., network B) establishes each RRC connection and transmit/receives data at the same time.

In this scenario, the network A may configure conditional reconfiguration with one or more execution conditions to perform CHO, CPA or CPC with candidate target cells before the UE establishes the RRC connection in the network B.

If the conditional reconfiguration has been configured in the network A before establishing the RRC connection in the network B, the network A may provide a candidate cell configuration of some frequencies in the conditional reconfiguration that the candidate cell configuration can lead to a temporary hardware conflict due to operation on the frequency of the network B.

The problem is that when performing CHO, CPA or CPC, the UE may suffer a case that CA/DC configuration in the conditional reconfiguration cannot be fully supported due to the capability conflict/limitation caused by the capability used for operations with the network B, i.e., due to the temporary hardware conflict.

This is because the network A cannot know that the UE has established another RRC connection in the network B before performing CHO, CPA, or CPC without any notice from the UE.

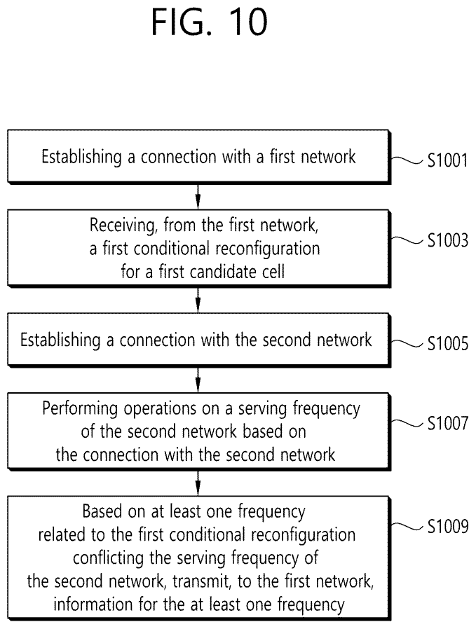

FIG. 10 shows an example of a method performed by a UE according to an embodiment of the present disclosure. The method may also be performed by a wireless device.

Referring to FIG. 10, in step S1001, the UE may establish a connection with a first network, and enter a connected state in the first network.

In step S1003, the UE may receive, from the first network, a first conditional reconfiguration for a first candidate cell.

In step S1005, the UE may establish a connection with the second network.

In step S1007, the UE may perform operations on a serving frequency of the second network based on the connection with the second network.

In step S1009, based on at least one frequency related to the first conditional reconfiguration conflicting the serving frequency of the second network, the UE may transmit, to the first network, information for the at least one frequency, after the connection with the second network is established.

According to various embodiments, the at least one frequency conflicting the serving frequency of the second network may comprise a capability of the UE being not able to support simultaneously performing operations on the at least one frequency and operations on the serving frequency of the second network. The at least one frequency may conflict the serving frequency of the second network based on at least one of: a case that the at least one frequency is adjacent to the serving frequency of the second network; a case the at least one frequency at least partially overlaps the serving frequency of the second network; or a case that the at least one frequency comprises the serving frequency of the second network.

According to various embodiments, the at least one frequency related to the first conditional reconfiguration for the first candidate cell may comprise at least one of: a frequency of the first candidate cell; or a frequency of at least one other cell associated with the first candidate cell. The first candidate cell may comprise at least one of a primary cell (PCell) or a primary secondary cell (PSCell). The at least one other cell may comprise at least one of: a PSCell related to a dual connectivity (DC) configuration in the first conditional reconfiguration; or one or more secondary cells (SCells) related to a carrier aggregation (CA) configuration in the first conditional reconfiguration.

According to various embodiments, the information for the at least one frequency may comprise at least one of: information indicating the at least one frequency; information indicating one or more cells on the at least one frequency; information indicating that there is a conflict between the at least one frequency and the serving frequency of the second network; or information indicating at least one of a dual connectivity (DC) configuration or a carrier aggregation (CA) configuration related to one or more cells on the at least one frequency.

According to various embodiments, the information for the at least one frequency may be transmitted via a UE assistance information message.

According to various embodiments, after transmitting the information for the at least one frequency, the UE may receive, from the network, a second conditional reconfiguration for a second candidate cell. Any frequency related to the second conditional reconfiguration does not conflict the serving frequency of the second network.

According to various embodiments, the second conditional reconfiguration may comprise an indication not to release the first conditional reconfiguration after receiving the second conditional reconfiguration.

According to various embodiments, the second candidate cell may be different from the first candidate cell, based on the at least one frequency comprising a frequency of the first candidate cell. The second candidate cell may be identical to the first candidate cell, based on the at least one frequency not comprising the frequency of the first candidate cell and comprising a frequency of at least one other cell related to a dual connectivity (DC) configuration or a carrier aggregation (CA) configuration in the first conditional reconfiguration.

According to various embodiments, the UE may determine whether a conflict between the at least one frequency related to the first conditional reconfiguration and the serving frequency of the second network is resolved. Based on a determination that the conflict is resolved, the UE may apply the first conditional reconfiguration. For example, the determination that the conflict is resolved may be based on the connection with the second network being released. Based on a determination that the conflict is not resolved, the UE may apply the second conditional reconfiguration.

According to various embodiments, the applying of the first conditional reconfiguration may comprise: evaluating an execution condition for the first candidate cell in the first conditional reconfiguration; and applying a candidate cell configuration for the first candidate cell in the first conditional reconfiguration and performing a mobility to the first candidate cell, based on the execution condition for the first candidate cell being satisfied. The applying of the second conditional reconfiguration may comprise: evaluating an execution condition for the second candidate cell in the second conditional reconfiguration; and applying a candidate cell configuration for the second candidate cell in the second conditional reconfiguration and performing a mobility to the second candidate cell, based on the execution condition for the second candidate cell being satisfied.

According to various embodiments, the UE may be a multiple universal subscriber identity module (MUSIM) UE equipped with USIMs comprising a first SIM and a second SIM. The UE may register to the first network based on subscription information stored in the first SIM. The UE may register to the second network based on subscription information stored in the second SIM.

According to various embodiments, the UE may register to a first network and a second network. The UE may receive, from the first network, a first conditional mobility configuration with one or more execution conditions to perform mobility. The UE may send, to the first network, a request for an updated conditional mobility configuration before performing mobility based on the first conditional mobility configuration. The request may indicate that UE capability for one or more additional cell groups or serving cells should be temporarily restricted when performing a mobility. The UE may receive, from the first network, a second conditional mobility configuration with one or more execution conditions to perform mobility. The second conditional mobility configuration may be an alternative option of the first conditional mobility configuration. The UE may check whether temporary restriction of the UE capability is still required for one or more additional cell groups or serving cells on the first network when performing the mobility based on the first conditional mobility configuration.

The UE may apply the second conditional mobility configuration for the mobility if the temporary restriction of the UE capability is still required for one or more additional cell groups or serving cells on the first network.

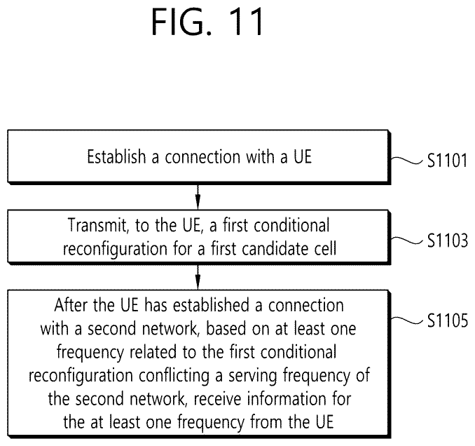

FIG. 11 shows an example of a method performed by a network node in a first network according to an embodiment of the present disclosure.

Referring to FIG. 11, in step S1101, the network node may establish a connection with a UE.

In step S1103, the network node may transmit, to the UE, a first conditional reconfiguration for a first candidate cell.

In step S1105, after the UE has established a connection with a second network, based on at least one frequency related to the first conditional reconfiguration conflicting a serving frequency of the second network, the network node may receive information for the at least one frequency from the UE.

According to implementations of the present disclosure, while performing Multi-USIM operation, after establishing the RRC connection in the second network (the network B) successfully, the UE may determine if any conditional reconfiguration for CHO, CPC, or CPA has been configured in the first network (the network A) before RRC connection establishment in the second network and if the conditional reconfiguration may lead to a configuration that cannot be fully supported (e.g., incomplete CA/DC configuration when applying the conditional reconfiguration) in the first network due to the capability conflict/limitation caused by the capability used for operations with the second network.

If the UE determines that the conditional reconfiguration may lead to the problem such as incomplete configuration and/or capability conflict when the UE successfully complete the RRC connection establishment in the network B, the UE may request to update the conditional reconfiguration to prevent the problem which leads to a configuration that cannot be fully supported (e.g., incomplete CA/DC configuration when applying the conditional reconfiguration) in the first network due to the capability conflict/limitation caused by the capability used for operations with the second network. This request may be transmitted for temporary capability restriction in the first network to solve the problem caused by Multi-USIM operation (e.g., RRC connection establishment in the second network). The UE may send another request to receive a fully supported configuration again (i.e., release the temporary capability restriction) when the problem is resolved (e.g., by RRC connection release in the second network).

For the request to update the conditional reconfiguration, the UE may send an RRC dedicated signalling, e.g., UEAssistanceInformation message, to the first network. The UE may indicate to the first network at least one of the followings:
which candidate cells of some frequencies in the conditional reconfiguration can cause the problem, if one of the candidate cells of those frequencies becomes a serving cell (e.g., PCell or PSCell) in the first network and if radio resources related to the frequency are configured in the first network; and/or
which other cells of some frequencies for CA/DC in the conditional reconfiguration can cause the problem, if one of the other cells of those frequencies becomes a serving cell (e.g., SCell or SCG SCell) in the first network and if radio resources related to the frequency are configured in the first network.

After sending the RRC dedicated signalling to request to update the conditional reconfiguration, the UE may receive an updated conditional reconfiguration for CHO, CPC, or CPA according to the UE request (i.e., in the updated reconfiguration, there is no such problem that has been indicated when applying the conditional reconfiguration). The first network may provide an indication that the previous conditional reconfiguration can be still kept to apply if the problem has been resolved (e.g., by RRC release in the network B later) when the execution condition is met. Then, the UE may keep two sets of conditional reconfigurations for the same candidate cells until at least one execution condition for the conditional reconfiguration is met.

When the execution is met and the indication has been provided from the first network, the UE may check whether the conditional reconfiguration may still lead to the problem such as incomplete configuration and/or capability conflict due to Multi-USIM operation. If the problem is still valid when applying the conditional reconfiguration, the UE may apply the updated conditional reconfiguration for CHO, CPC, or CPA. Otherwise, i.e., there is no problem, the UE may apply the previous conditional reconfiguration for CHO, CPC, or CPA.

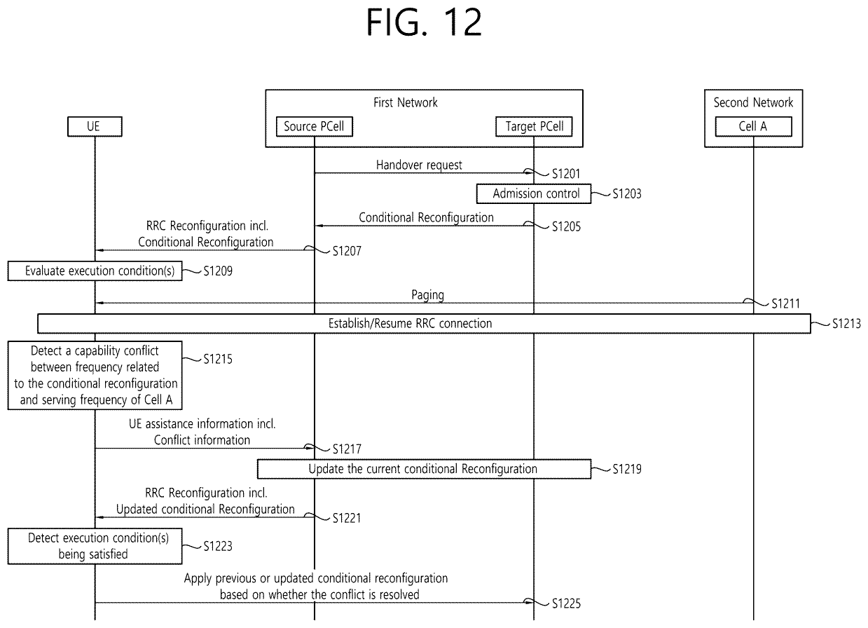

FIG. 12 shows an example of a signal flow for MUSIM operation according to an embodiment of the present disclosure.

Referring to FIG. 12, in step S1201, the source PCell in the first network may decide to hand off the UE and issue a handover request message to the target PCell for CHO.

In step S1203, upon reception of the handover request message from the source PCell, the target PCell in the first network may perform admission control for the UE. The target PCell may also decide to provide conditional reconfiguration, i.e., CHO. In the conditional reconfiguration, CA/DC configuration supposed to be applied when performing CHO is also included.

In step S1205, the target PCell in the first network may transmit the conditional reconfiguration to the source PCell.

In step S1207, upon reception of the conditional reconfiguration from the target PCell, the source PCell may transmit RRC reconfiguration message comprising the conditional reconfiguration to the UE with one or more execution conditions. The UE may receive the RRC Reconfiguration message including reconfiguration with sync with the execution conditions, i.e., the handover command for CHO from the source PCell to the target PCell. The UE store the conditional reconfiguration for CHO, i.e., add a new entry for this CHO within a UE variable. The UE variable may include the accumulated configuration of the CHO.

In step S1209, after storing the conditional reconfiguration, the UE may start evaluating the execution conditions to perform handover to the target PCell.

In step S1211, the UE may receive a paging/paging message on Cell A to establish an RRC connection.

In step S1213, upon reception of the paging/paging message, the UE may decide to establish the RRC connection on the Cell A. The UE may send RRC setup request or RRC resume request message to the Cell A. After sending the RRC setup request or RRC resume request message, the UE may receive RRC setup or RRC resume message to establish/resume the RRC connection from the Cell A. The UE may successfully complete the RRC connection on the Cell A, and transmit RRC setup complete or RRC resume complete message to the Cell A.

In step S1215, the UE may detect a capability conflict between frequency related to the conditional reconfiguration and serving frequency of Cell A. That is, after successful completion of the RRC connection in the second network, the UE may check if the conditional reconfiguration for CHO may have any frequency information which can lead to the problem such as incomplete configuration and/or capability conflict with the serving frequency of the Cell A in the second network, and detect that the conditional reconfiguration for CHO may have any frequency information which can lead to capability conflict with the serving frequency of the Cell A in the second network.

In step S1217, the UE may send an RRC dedicated signalling, e.g., UE Assistance Information, to indicate that the conditional reconfiguration for CHO may cause the problem such as incomplete configuration and/or capability conflict due to Multi-SIM operation when one of the execution condition is satisfied. The UE may also indicate which configuration, e.g., CA/DC configuration in the conditional reconfiguration can be the problem related to the serving frequency/frequencies in the second network i.e., information for at least one frequency related to the conditional reconfiguration conflicting the serving frequency of the Cell A in the second network.

In step S1219, upon reception of the RRC dedicated signalling to indicate the problem from the UE, the source PCell may exchange signalling to the target PCell to update the current conditional reconfiguration to resolve the problem. After exchanging signalling between the source PCell and the target PCell, an updated conditional reconfiguration that doesn't include the problem has been prepared by temporarily restricted CA/DC configuration.

In step S1221, the source PCell may transmit RRC reconfiguration message comprising the updated conditional reconfiguration to the UE. In the updated conditional reconfiguration, an additional indication may be included to allow that the previous conditional reconfiguration can be still kept together with the updated conditional reconfiguration. Upon reception of RRC Reconfiguration message including reconfiguration with sync for the updated conditional reconfiguration, the UE may store the updated conditional reconfiguration for CHO. Also, if the additional indication is included, the UE may keep the previous conditional reconfiguration i.e., may not release the previous conditional reconfiguration.

In step S1223, the UE may detect execution condition(s) being satisfied. When at least one execution condition for CHO is met, the UE may check whether the capability conflict has been resolved i.e., whether the RRC connection has been released on the Cell A in the second network.

In step S1225, if the capability conflict has been resolved i.e., the RRC connection has been released on the Cell A, the UE may regard the problem that has been indicated to the source PCell as being resolved and apply the previous conditional reconfiguration for CHO, i.e., not updated handover command and start the T304 timer. Otherwise, i.e., if the capability conflict has not been resolved/RRC connection is still maintained on the Cell A, the UE may regard the problem that has been indicated to the source PCell as being still valid, apply the updated conditional reconfiguration for CHO and start the T304 timer.

Before an expiry of the timer, the UE may perform synchronisation to the target PCell and access the target PCell via RACH configuration which is configured by the RRC reconfiguration message i.e., target cell configuration in the corresponding conditional reconfiguration.

After successfully complete of synchronisation to the target PCell, the UE may send RRC Reconfiguration Complete message with information to indicate which conditional reconfiguration is applied.

Furthermore, the method in perspective of the UE described in the present disclosure (e.g., in FIG. 10) may be performed by the first wireless device 100 shown in FIG. 2 and/or the UE 100 shown in FIG. 3.

More specifically, the UE comprises at least one transceiver, at least processor, and at least one computer memory operably connectable to the at least one processor and storing instructions that, based on being executed by the at least one processor, perform operations.

The operations comprise: establishing a connection with a first network; receiving, from the first network, a first conditional reconfiguration for a first candidate cell; establishing a connection with the second network; performing operations on a serving frequency of the second network based on the connection with the second network; and based on at least one frequency related to the first conditional reconfiguration conflicting the serving frequency of the second network, transmitting, to the first network, information for the at least one frequency, after the connection with the second network is established.

Furthermore, the method in perspective of the UE described in the present disclosure (e.g., in FIG. 10) may be performed by a software code 105 stored in the memory 104 included in the first wireless device 100 shown in FIG. 2.

More specifically, at least one computer readable medium (CRM) stores instructions that, based on being executed by at least one processor, perform operations comprising: establishing a connection with a first network; receiving, from the first network, a first conditional reconfiguration for a first candidate cell; establishing a connection with the second network; performing operations on a serving frequency of the second network based on the connection with the second network; and based on at least one frequency related to the first conditional reconfiguration conflicting the serving frequency of the second network, transmitting, to the first network, information for the at least one frequency, after the connection with the second network is established.

Furthermore, the method in perspective of the UE described in the present disclosure (e.g., in FIG. 10) may be performed by control of the processor 102 included in the first wireless device 100 shown in FIG. 2 and/or by control of the processor 102 included in the UE 100 shown in FIG. 3.

More specifically, an apparatus configured to/adapted to operate in a wireless communication system (e.g., wireless device/UE) comprises at least processor, and at least one computer memory operably connectable to the at least one processor. The at least one processor is configured to/adapted to perform operations comprising: establishing a connection with a first network; receiving, from the first network, a first conditional reconfiguration for a first candidate cell; establishing a connection with the second network; performing operations on a serving frequency of the second network based on the connection with the second network; and based on at least one frequency related to the first conditional reconfiguration conflicting the serving frequency of the second network, transmitting, to the first network, information for the at least one frequency, after the connection with the second network is established.

Furthermore, the method in perspective of the network node in a first network described in the present disclosure (e.g., in FIG. 11) may be performed by the second wireless device 200 shown in FIG. 2.

More specifically, the network node comprises at least one transceiver, at least processor, and at least one computer memory operably connectable to the at least one processor and storing instructions that, based on being executed by the at least one processor, perform operations.

The operations comprise: establishing a connection with a user equipment (UE); transmitting, to the UE, a first conditional reconfiguration for a first candidate cell; and after the UE has established a connection with a second network, based on at least one frequency related to the first conditional reconfiguration conflicting a serving frequency of the second network, receiving information for the at least one frequency from the UE.

The present disclosure may have various advantageous effects.

For example, since the UE can request updated configuration (temporarily restricted configuration for the conditional reconfiguration) to the network before applying the conditional reconfiguration, the UE can prevent unnecessary data transmission delay caused by the conflict due to MUSIM operation after applying the conditional reconfiguration.

Advantageous effects which can be obtained through specific embodiments of the present disclosure are not limited to the advantageous effects listed above. For example, there may be a variety of technical effects that a person having ordinary skill in the related art can understand and/or derive from the present disclosure. Accordingly, the specific effects of the present disclosure are not limited to those explicitly described herein, but may include various effects that may be understood or derived from the technical features of the present disclosure.

Claims in the present disclosure can be combined in a various way. For instance, technical features in method claims of the present disclosure can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method. Other implementations are within the scope of the following claims.

1. A method comprising
establishing a connection with a first network;
receiving, from the first network, a first conditional reconfiguration for a first candidate cell;
establishing a connection with the second network;
performing operations on a serving frequency of the second network based on the connection with the second network; and
based on at least one frequency related to the first conditional reconfiguration conflicting the serving frequency of the second network, transmitting, to the first network, information for the at least one frequency, after the connection with the second network is established.

2. The method of claim 1, wherein the at least one frequency conflicting the serving frequency of the second network comprises a capability of the UE being not able to support simultaneously performing operations on the at least one frequency and operations on the serving frequency of the second network, and
wherein the at least one frequency conflicts the serving frequency of the second network based on at least one of:
a case that the at least one frequency is adjacent to the serving frequency of the second network;
a case the at least one frequency at least partially overlaps the serving frequency of the second network; or
a case that the at least one frequency comprises the serving frequency of the second network.

3. The method of claim 1, wherein the at least one frequency related to the first conditional reconfiguration for the first candidate cell comprises at least one of:
a frequency of the first candidate cell; or
a frequency of at least one other cell associated with the first candidate cell,
wherein the first candidate cell comprises at least one of a primary cell (PCell) or a primary secondary cell (PSCell), and
wherein the at least one other cell comprises at least one of:
a PSCell related to a dual connectivity (DC) configuration in the first conditional reconfiguration; or
one or more secondary cells (SCells) related to a carrier aggregation (CA) configuration in the first conditional reconfiguration.

4. The method of claim 1, wherein the information for the at least one frequency comprises at least one of:
information indicating the at least one frequency;
information indicating one or more cells on the at least one frequency;
information indicating that there is a conflict between the at least one frequency and the serving frequency of the second network; or
information indicating at least one of a dual connectivity (DC) configuration or a carrier aggregation (CA) configuration related to one or more cells on the at least one frequency.

5. The method of claim 1, wherein the information is transmitted via a UE assistance information message.

6. The method of claim 1, further comprising:
after transmitting the information for the at least one frequency, receiving, from the network, a second conditional reconfiguration for a second candidate cell,
wherein any frequency related to the second conditional reconfiguration does not conflict the serving frequency of the second network.

7. The method of claim 6, wherein the second conditional reconfiguration comprises an indication not to release the first conditional reconfiguration after receiving the second conditional reconfiguration.

8. The method of claim 6, wherein the second candidate cell is different from the first candidate cell, based on the at least one frequency comprising a frequency of the first candidate cell; and
wherein the second candidate cell is identical to the first candidate cell, based on the at least one frequency not comprising the frequency of the first candidate cell and comprising a frequency of at least one other cell related to a dual connectivity (DC) configuration or a carrier aggregation (CA) configuration in the first conditional reconfiguration.

9. The method of claim 6, further comprising determining whether a conflict between the at least one frequency related to the first conditional reconfiguration and the serving frequency of the second network is resolved;
based on a determination that the conflict is resolved, applying the first conditional reconfiguration; and
based on a determination that the conflict is not resolved, applying the second conditional reconfiguration.

10. The method of claim 9, wherein the determination that the conflict is resolved is based on the connection with the second network being released.

11. The method of claim 9, wherein the applying of the first conditional reconfiguration comprises:
evaluating an execution condition for the first candidate cell in the first conditional reconfiguration; and
applying a candidate cell configuration for the first candidate cell in the first conditional reconfiguration and performing a mobility to the first candidate cell, based on the execution condition for the first candidate cell being satisfied; and
wherein the applying of the second conditional reconfiguration comprises:
evaluating an execution condition for the second candidate cell in the second conditional reconfiguration; and
applying a candidate cell configuration for the second candidate cell in the second conditional reconfiguration and performing a mobility to the second candidate cell, based on the execution condition for the second candidate cell being satisfied.

12. The method of claim 1, wherein the method is performed by a user equipment (UE) which is a multiple universal subscriber identity module (MUSIM) UE equipped with USIMs comprising a first SIM and a second SIM, and
wherein the method further comprises:
registering to the first network based on subscription information stored in the first SIM; and
registering to the second network based on subscription information stored in the second SIM.

13. The method of claim 1, wherein the method is performed by a user equipment (UE) is in communication with at least one of a mobile device, a network, or autonomous vehicles.

14. A user equipment (UE) comprising:
at least one transceiver;
at least one processor; and
at least one memory operatively coupled to the at least one processor and storing instructions that, based on being executed by the at least one processor, perform operations comprising:
establishing a connection with a first network;
receiving, from the first network, a first conditional reconfiguration for a first candidate cell;
establishing a connection with the second network;
performing operations on a serving frequency of the second network based on the connection with the second network; and
based on at least one frequency related to the first conditional reconfiguration conflicting the serving frequency of the second network, transmitting, to the first network, information for the at least one frequency, after the connection with the second network is established.

15. (canceled)

16. A network node in a first network comprising:
at least one transceiver;
at least one processor; and
at least one memory operatively coupled to the at least one processor and storing instructions that, based on being executed by the at least one processor, perform operations comprising:
establishing a connection with a user equipment (UE);
transmitting, to the UE, a first conditional reconfiguration for a first candidate cell; and
after the UE has established a connection with a second network, based on at least one frequency related to the first conditional reconfiguration conflicting a serving frequency of the second network, receiving information for the at least one frequency from the UE.

17-20. (canceled)
